(19) United States
(12) Patent Application Publication
(10) Pub. No.: US 2014/0348394 A1
(43) Pub. Date: Nov. 27, 2014

(54) PHOTOGRAPH DIGITIZATION THROUGH THE USE OF VIDEO PHOTOGRAPHY AND COMPUTER VISION TECHNOLOGY

(71) Applicant: PICSURED, INC., San Francisco, CA (US)

(72) Inventors: Robert Salaverry, San Francisco, CA (US); Scott Shebby, San Francisco, CA (US)

(21) Appl. No.: 14/347,239

(22) PCT Filed: Sep. 27, 2012
(86) PCT No.: PCT/US2012/057601

§ 371 Date: Mar. 25, 2014

Related U.S. Application Data
(60) Provisional application No. 61/539,935, filed on Sep. 27, 2011.

(51) Int. Cl. G06T 7/00; G06K 9/00

(52) U.S. Cl. CPC G06T 7/0002; G06K 9/00442; G06K 2209/50; G06T 2207/30168
USPC 382/112

(57) ABSTRACT

Systems, methods, and computer readable storage mediums are provided for photograph digitization through the use of video photography and computer vision technology in accordance with various embodiments. A number of video frames are received. Each video frame includes a respective image of a physical print (or a portion thereof). For at least some of the video frames, a rating value is assigned to image of the physical print (or portions thereof). The rating value is in accordance with rating criteria. A highest quality image of the physical print is selected from among the respective images. The selection based on at least the rating value of the selected image. The highest quality image is stored as a final digital representation of the physical print.

### TECHNICAL FIELD

The present invention relates to the technical field of video photography and computer vision. More particularly, the present invention is in the technical field of using computer vision as it relates to detecting images in video.

### BACKGROUND

Photographs are an important piece of memorabilia in the lives of many people. Photographic prints relating to childhood, weddings, vacations and other occasions are commonly placed in photo albums, photograph frames, and a range of other display environments.

Today with the advent of digital photography one of the most frequent activities that people engage in is sharing photographs in online photo albums, through social networks such as, but not limited to Facebook and through email and other online sharing methods. Individuals also like to backup and archive copies of photographs. But this can only be accomplished if the photographs are in digital format.

Most people consider their personal photographs some of the most important assets they have in life. But so many photographs are locked in a physical format and are not being shared. People have memories, facts and information about photographs. People like to tell stories, share family memories or share particular information related to their photograph images. However all this information is being lost in time. Information and stories which are naturally communicated through speech when looking at a photograph are not being told. Today using the current methods of scanning there is no easy method to vocally capture and associate the existing information or memories relevant to a photograph with the photograph image

Furthermore it is difficult to remove photographs from photo albums, photograph frames, or other physical holding environments where the group of photographs resides. People often do not want to take the chance of doing so for risk of tearing the photographs, or removing photographs from an existing location.

### SUMMARY OF INVENTION

This invention allows someone to create a digital copy of any group of photograph images that is visible on any visual surface.

Furthermore this invention allows for the instantaneous capture of multiple images of the same photograph image which can then later be automatically ranked in order to arrive and select the highest quality image from multiple digital copies of the same photograph.

The invention allows people to vocally describe, capture and share information and memories associated with a specific photograph through voice annotations related to the photograph or specific sections of the photograph while in the process of creating a digital copy of the photograph.

All of this can be accomplished without the use of expensive scanners and can be accomplished by anyone familiar with basic video photography and who possess a video recording device such as the video recorder in a smart phone, digital camera, DSLR or Camcorder.

### BRIEF DESCRIPTION OF DRAWINGS

FIG. 1 Key Steps of the Method

100 Video, Audio and Data Capture

FIG. 2 Group of images on Surface being recorded

FIG. 3 Embodiment to capture photo four vertices

FIG. 4 Creation of multiple image

FIG. 5 Capturing Multiple Photograph Images in each Scene

FIG. 6 Video Capture through Touch Motion

FIG. 7 Use of Voice Markers

FIG. 8 Voice annotation of specific areas of interest in a photograph

200 Video, Audio and Data Conversion

FIG. 9 Conversion of Video data file into a video stream of scenes

FIG. 10 Audio File Conversion

FIG. 11 Creation of associated data blocks of Audio, Video and Data

FIG. 12 Other data conversion

300 Image Detection

FIG. 13 Image Detection Overview

FIG. 14 Detailed Computer Vision Image Detection process

400 Extraction and Association Process

FIG. 15 Rate, Rank and Adjust Process

FIG. 16 Creation of Picsured Digital Media (PDM)

Additional Figures and Descriptions

FIG. 17 Server System

FIG. 18 Client System

FIG. 19 Summary

FIG. 20 Summary of Another Embodiment

### DETAILED DESCRIPTION

Photograph scanners have proven to be a popular means for converting a group of physical photographic images into digital images.

The most common approach to scanning involves inserting a physical photographic image onto a scanner glass bed. Other solutions involve using scanner housing that may employ the auto-feed scan mechanism to automatically pull a physical photographic image into the scanner housing for scanning And there are also some newer smart phone applications that scan photographs. All these approaches essentially use the same scanning methodology which involves scanning one image at a time. Some scanners scan more quickly and other more slowly.

These approaches to digitizing photographs rely on capturing in one scan a single accurate high quality duplication of each physical photograph during the scanning process in order to arrive at a high quality digital copy. Using the current method only visual data is captured at the time of scanning the photographic print image.

Whether using a scanner, an application on a smart phone that scans photo images or other traditional photo image scanning equipment all current methods are using a traditional scanning methodology. Unless you purchase expensive equipment with auto feed capabilities, for most people using the current approach to scanning remains laborious and time consuming because the current methods of scanning involve scanning each image one by one. As a result very few people attempt or spend the time to digitize and create duplicate digital copies of their personal printed photographs.

Current methods that involve using an auto-feed mechanism to automatically pull a physical photographic image from a group of photos in scanner are fast but require expensive equipment, take up a lot of space and are not very easy to move around and as a result are not convenient, accessible and generally easy to use for most consumers.

In addition any method that relies on placing a photograph album or other photograph holding devices on a flat bed scanner is cumbersome and becomes difficult when the photograph album or any other photograph holding device are of different thickness and weight, possibly resulting the in the scanner cover not being able to close sufficiently on a scanner. These approaches do not address the various sizes and shapes of photo albums or other holding devices. These approaches listed above use devices that may not be easily transported, and therefore, may not be well-suited for use in many locations.

Furthermore, drawbacks associated with using most of the traditional scanners are that these approaches do not address the difficultly of how to physically extract photographs from certain locations where a group of photograph images reside such as photo albums, glass displays, photograph frames and other holding environments of various kinds

Other methods such as using a smart phone application make it easier to move the scanning device around and scan images on various surfaces, but conversely are slow and time consuming because they continue to rely on existing methods of scanning one image at a time.

Also if there is a group of photos that are loosely coupled and organized in a certain order be it in an album, a pile of photographs, or photographs in a scrapbook it is time consuming to remove them and then scan them one by one, and then return them back in the correct order into the said photo album, pile of photographs, shoe box, a drawer, a set of photograph frame or other holding environment in their original sequence and previously organized state.

Furthermore it is not easy to organize and group photographs images that have been digitized using any of the current methods of scanning as the current methods create single digital copies of each photographic printed image and there is no easy way to organize them in the same grouping that they were physically residing in their original physical state.

Additional drawbacks include the fact that most scanners try to create one high quality digital copy of a photograph image with a single scan. This approach is not very forgiving if a mistake takes place during the one time scanning process.

Furthermore the current methods does not allow for ability to create multiple copies of the same photograph image and then rank and identify the highest quality image from an array of digital copies of the same photograph image or create higher quality images based on selecting and stitching together the highest quality regions of multiple frames of the same image to arrive at a generally higher quality image.

Finally the current method to scan digital photographs are essentially one dimensional, meaning you are only scanning the visual photographic image and only gathering and recreating visual data. Using all current methods of scanning you can not capture at the time of scanning any voice based communication or audio annotations that may provide insight or context about the photograph and associate that information with the digitized copy of the original physical photographic image.

U.S. Pat. No. 4,888,648 to Takeuchi et al. (Takeuchi) describes an electronic album configured to record, store and display images. In one embodiment, an image reader is configured to convert photographs, pictures or documents into electric signals to obtain corresponding image information that is stored in an image memory and displayed on a display. Index information associated with each image allows a particular image to be retrieved from the memory and displayed on the display. The device also has a keyboard and editor that allows a user to edit stored images.

The electronic album described in the Takeuchi patent has several drawbacks. Including that it can only scan photographs that are placed on a scanner bed at any one time and then requires the motion of lifting the scanner bed top and removing the photos before adding another set of photographs.

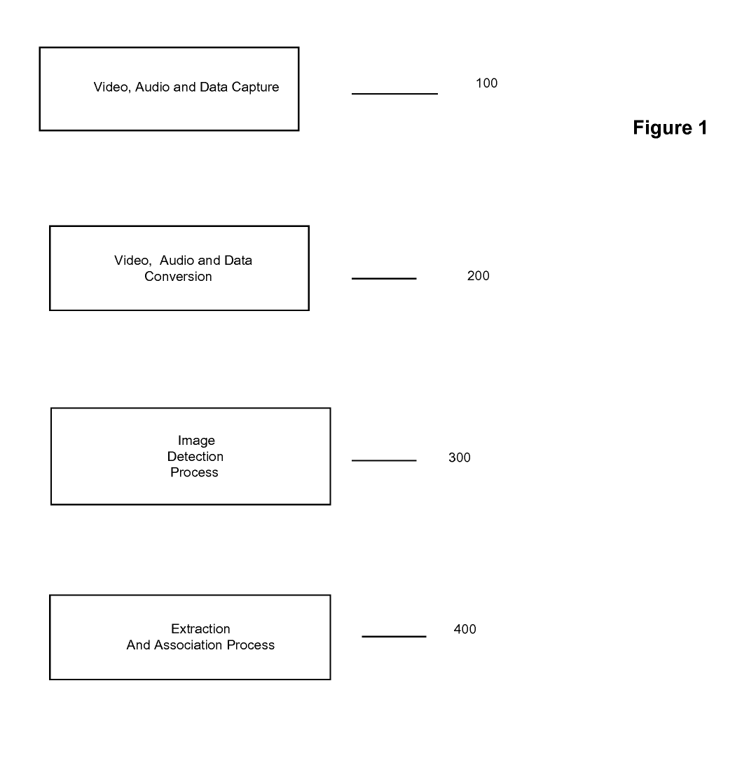

The invention as shown in FIGS. 1-20 is a process for converting any group of photograph images into multiple digital copies in order to create a high quality digital copy and to enable any voice annotation or other data associated with the image to be shared together with the digitized photograph image.

The environment in which this system can work includes, but is not limited to: any common computing environment, a personal computer, computer server, a smart phone, a tablet computer, embedded in a video camera or embedded in an SLR camera or any embedded system.

As shown in FIG. 1, this invention entails a process that involves Video, Audio and Data Capture 100, Video, Audio and Data Conversion 200, Image Detection 300, and Extraction and Association Process 400.

### List of Key Components of the Invention Per Each Step in the Method

### Video, Audio and Data Capture 100

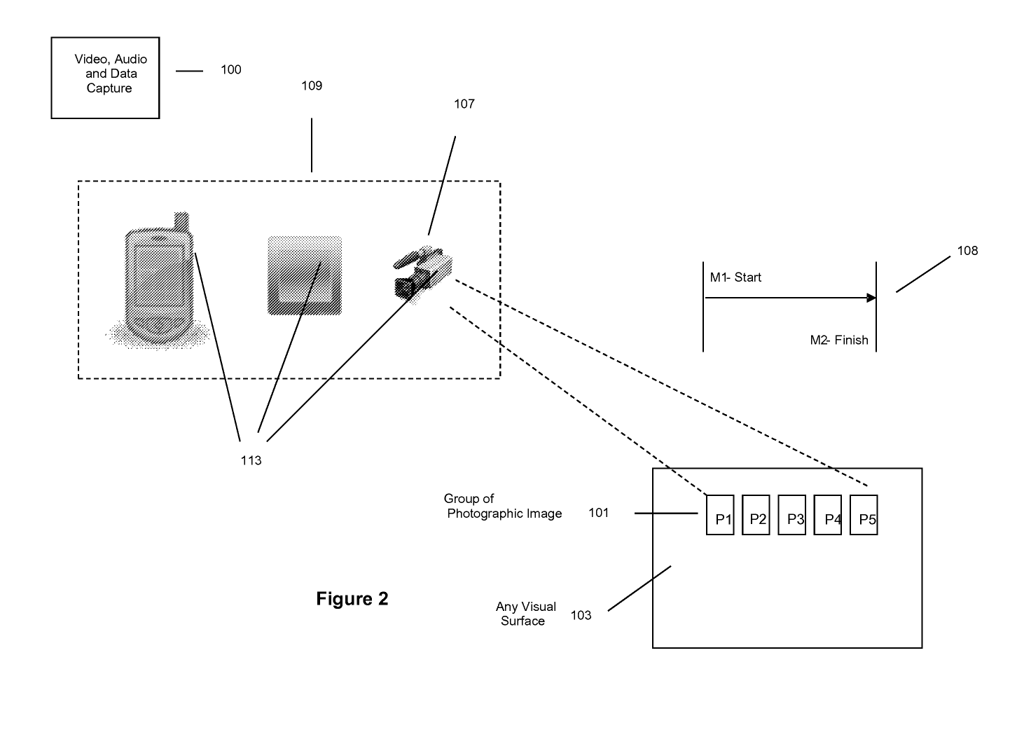

In more detail and referring to FIG. 2 there is shown as part of Video, Audio and Data Capture 100 a group of photograph images 101, any visual surface 103, a any number of video recording devices 109 such as a video camera 107. Still referring to FIG. 2 there is shown a video capture process starting at M1 Start to M2 Finish comprising video recording motion 108 where a video recording device such as a video camera 107 in the on position moves across a group of photograph images 101.

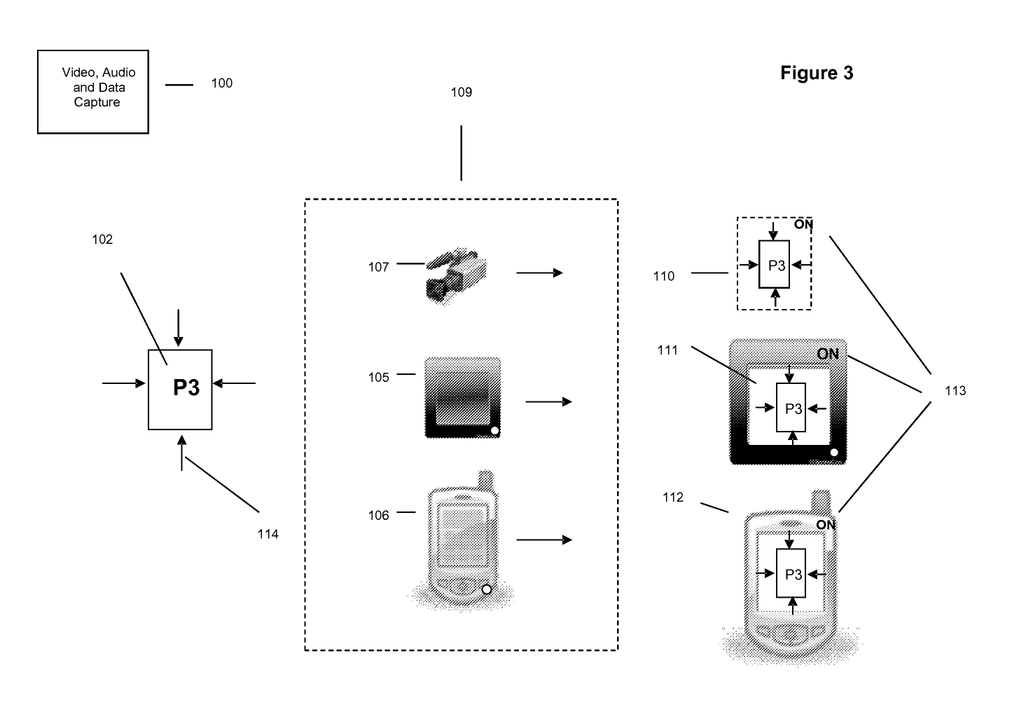

In more detail and referring to FIG. 3 there is shown a video camera 107, a touch sensitive computer tablet 105 and a touch or non touch sensitive smart phone 106. Also shown are a video camera screen and view finder 110, touch sensitive computer tablet 105 screen and view finder 111, touch sensitive smart phone screen and view finder 112. Also shown is an examples of a photographic image's 102 four outer vertices 114.

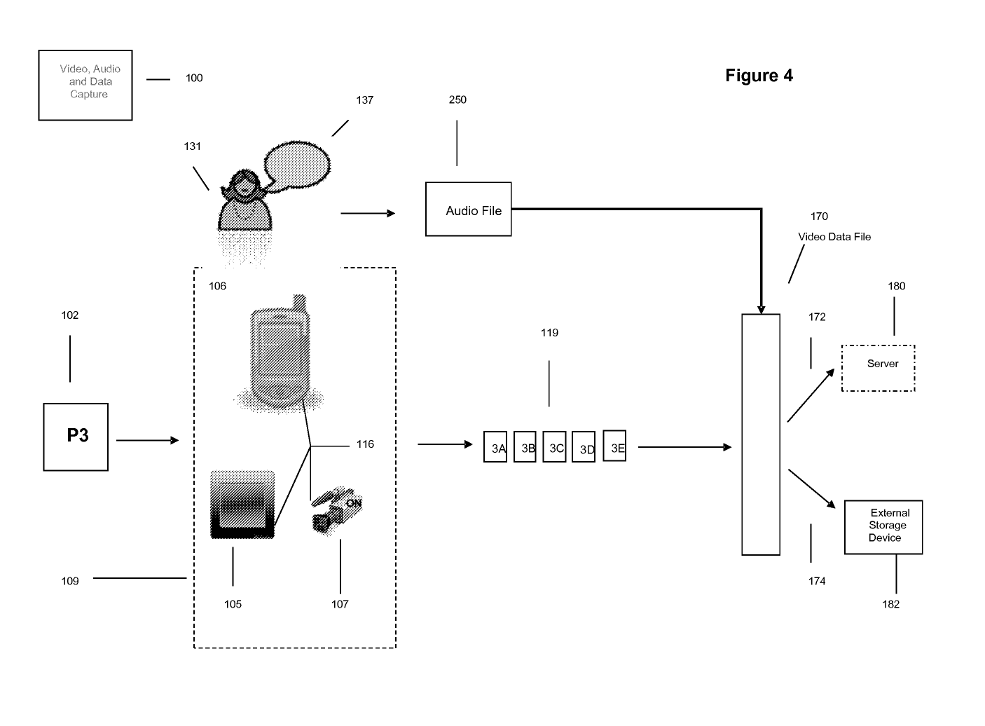

Referring to FIG. 4 there is shown the process of a creating multiple video frame image of the same scene 119 created by any number of video and audio recording devices 109. Also shown is the video data file 170 and the upload process 172 to deliver the video file to the server 180 and process of storing the video 174 on an external source 182. Also shown is the creation of a voice annotation 137, by a person 131 which is stored in an audio file 250 before the system passes it of the video data file.

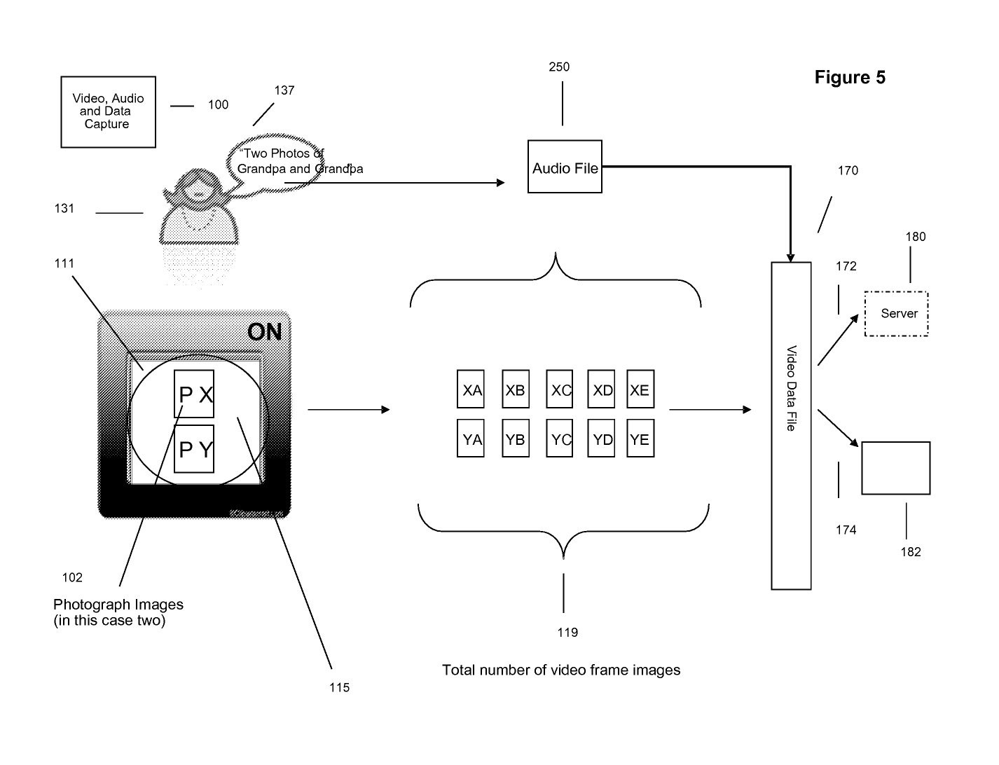

In more detail and referring to FIG. 5 there is shown multiple photograph images in one scene 118 captured in the touch sensitive computer tablet 105 screen and view finder 111. Our system is able to capture and convert multiple photograph images in one scene 118 using the same methods we use for capturing a single photograph image 102 per video recorded scene.

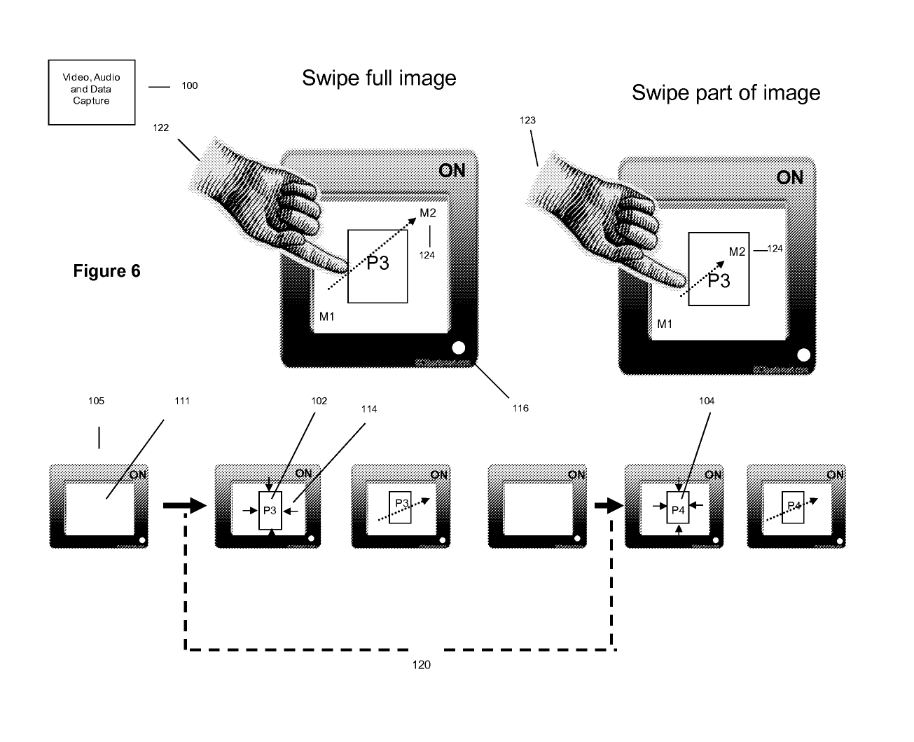

In FIG. 6 there is shown the movement 120 of the touch sensitive computer tablet device 105 over a photographic image 102. There is also shown the finger swipe motion 122 where a person is swiping a finger across the photographic image 102 in the view finder in order to video capture a given photograph. This swiping motion entails running a finger motion 122 across a sufficient portion of photograph to select it as shown from M1 to M2 in a Swipe Motion 124. This motion can be diagonally across or straight across from one of the outer vertices to the other outer vertices on the opposite side. In more detail and still referring to FIG. 6 there a person's finger swiping a portion 123 of the photograph image 102. There is also shown the movement 120 of the said device 105 over to the next photograph image 104 that may be residing on the same visual surface 103.

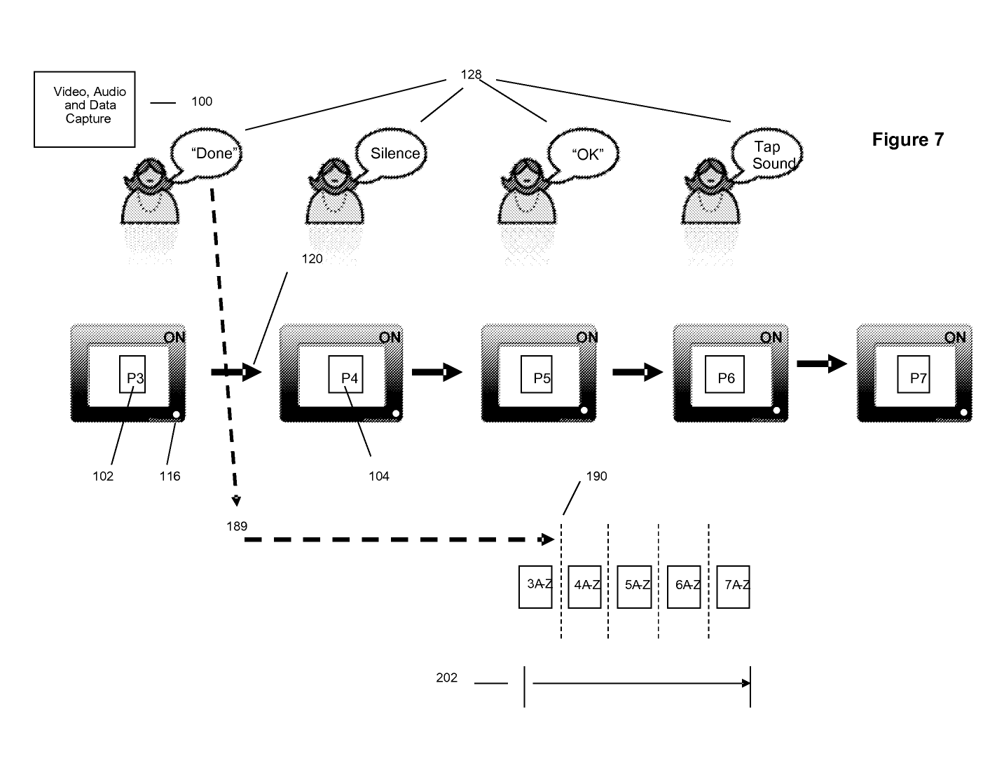

In FIG. 7 there is shown range of different audio marker 128 including spoken words such as “Done”, “OK”, time period of silence or specific verbal noises such as a Tap Sound. There is also shown a photograph image 102, the action of marking a specific point in time 189, a video stream 208, and audio marker tags 190. FIG. 7 also illustrates how the system uses audio marker tags 190 in the system when audio markers 128 are captured and result in the action of marketing a specific point in time 189 during the video and audio recording process. There is also shown the action of the system recognizing the movement 120 of the touch sensitive computer tablet recording device 105 to the next photographic image 104.

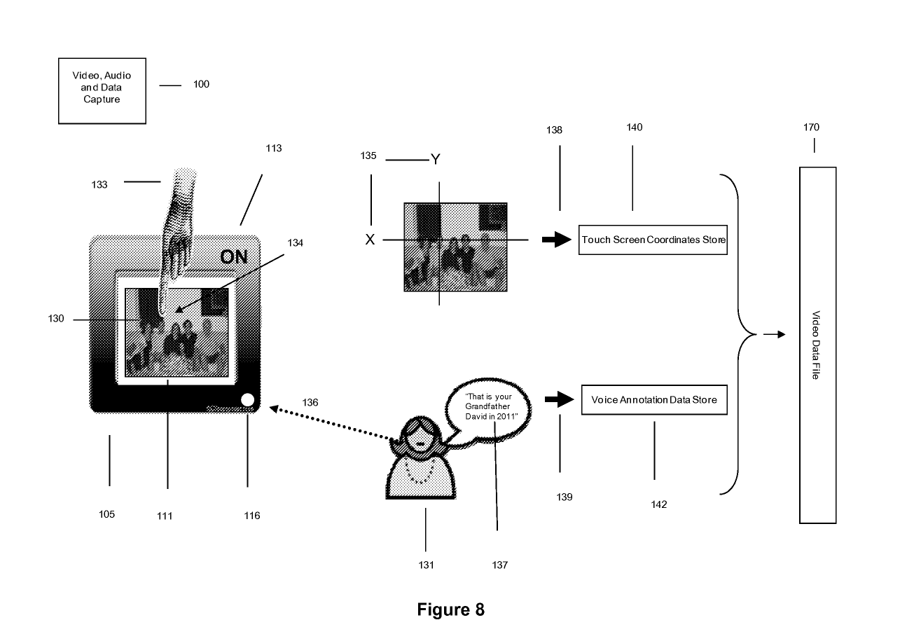

Referring to FIG. 8 there is shown an example of a voice annotation 137 being created by the person in order or share information, memories or facts related to the photograph image in general or to describe or explain a specific point(s) of interest 134 in the photograph image. These voice annotations can be created with any video recording device 109 that is cable of recording video and audio simultaneously.

In more detail and still referring to FIG. 8, there is shown a touch sensitive computer tablet 105 which is turned on in video and audio capture mode. The touch sensitive computer tablet's 105 screen and view finder 111 are shown viewing a graphical representation 130 of the physical photographic image 102. In more detail and still referring to FIG. 8 there is shown a person 131 using their finger 133 to point and touch on or near a specific point of interest 134 on the screen. At the same time and still referring to FIG. 8 the person 131 is speaking 136 and creating a voice annotation 137 in relation to specific touch screen coordinates they are touching in order to create a voice annotation with information relevant to the point where the person is touching the screen. This voice annotation 137 is captured by our system by using the audio recording device 116 in the 105 touch sensitive computer tablet 105.

There is also shown in FIG. 8 the system capturing the XY coordinates 135 and the action of placing 138 the XY coordinates 135 them in the systems touch screen coordinate store 140. There is also shown the system taking the voice annotation 137 and the action 139 of placing the voice annotation 137 into a voice annotation data store 142. Finally, there is shown the video data file 170 created by the video and audio capture 100 process which contains the touch screen data coordinates 135 and related voice annotation data 137.

### Video, Audio and Data Conversion 200

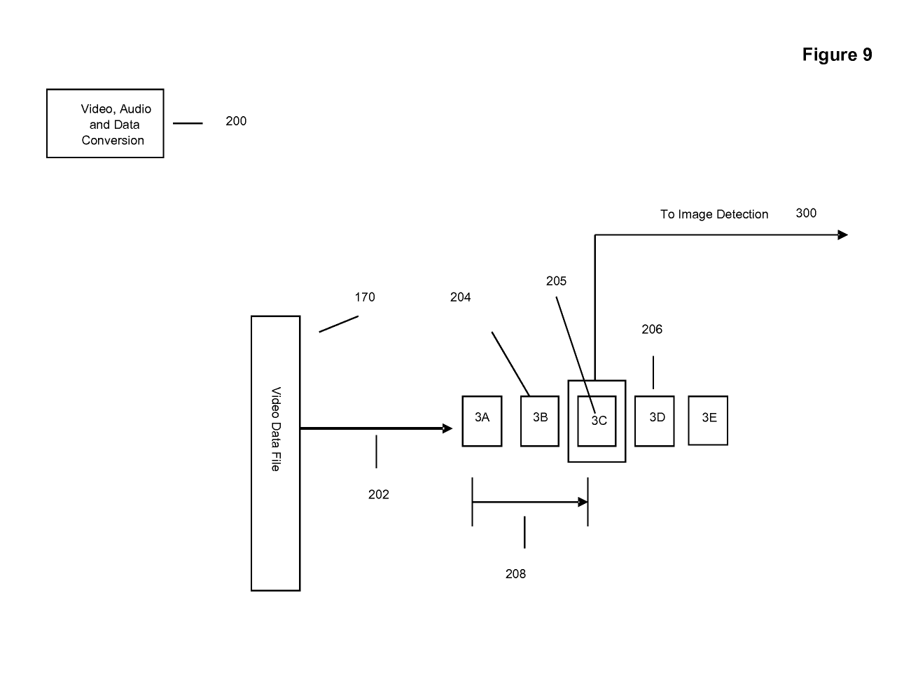

In more detail and referring to FIG. 9 as part of Video, Audio and Data Conversion process 200 there is also shown the upload process 172 from FIG. 4 and FIG. 5 and there is also shown the video data file 170. There is also shown a video stream 202, and a sequence of images 208 which include the prior video frame image of the same scene 204, the current video frame image of the same scene 205, and the next video frame image of the same scene 206.

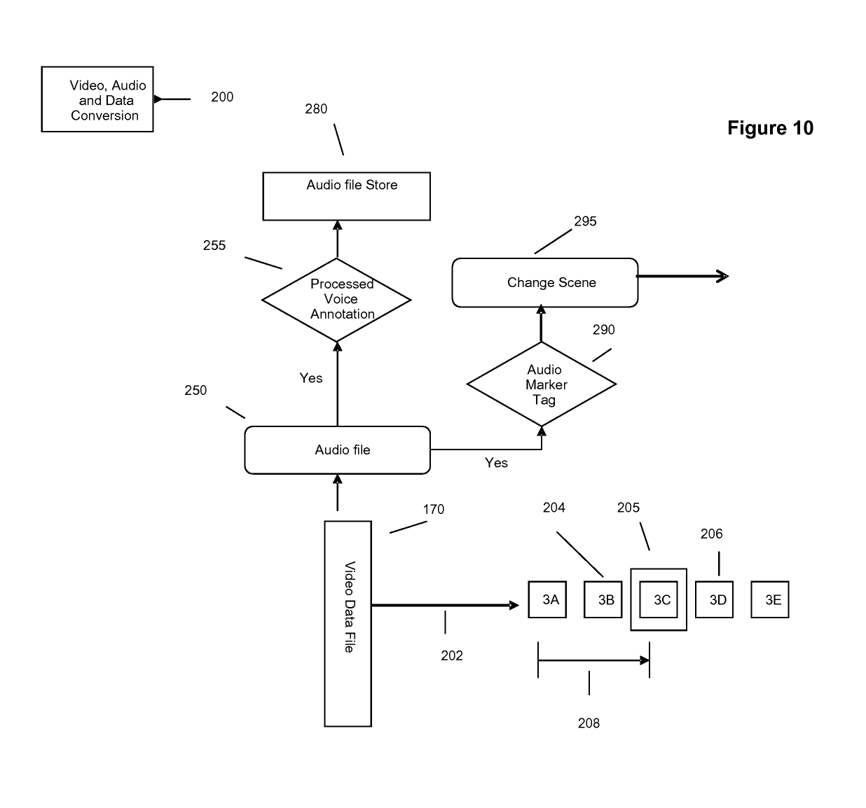

Referring to FIG. 10 there is shown as part of the Video and Audio Conversion 200 process, the following components: audio file 250, processed voice annotation 255, audio file store 280, audio marker tags 290, and change scene process 295.

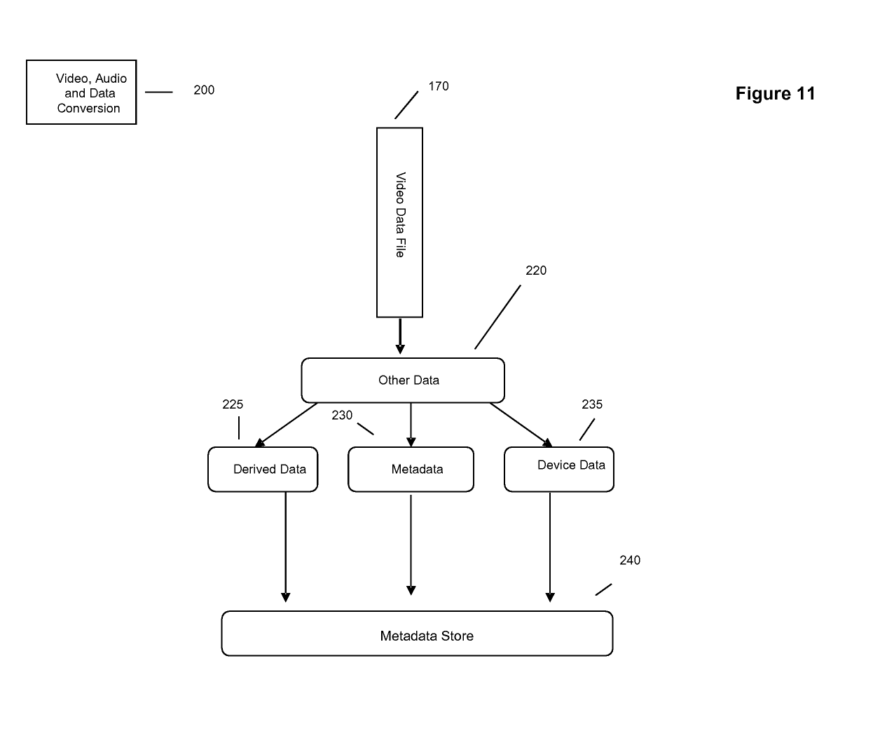

Referring to FIG. 11 there is shown as part of Video, Audio and Data Conversion 200 the following components. Other data 220 from the video file, which includes derived data 225, metadata 230 which includes metadata for time offsets or frame numbers and device data 235, which includes but is not limited to data that is generated from any software or hardware that is running on the device at the time of video and audio recording including but not limited to data gathered from the devices touch sensitive screens, accelerometers, GPS, and other device data that can be associated with the video and audio recording that takes places at a specific point in time of the photographic image 102. This also would include any data that is generated by a separate device that is gathering information that is to be associated with the video data. These various types of data reside in the metadata store 240.

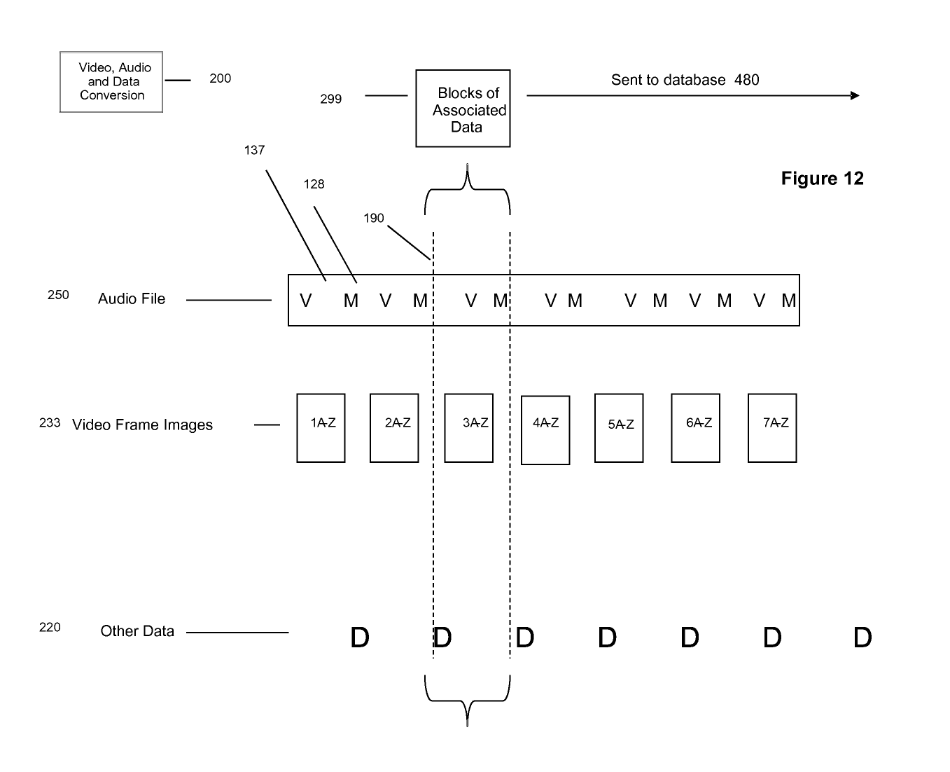

Referring to FIG. 12 there is shown a representation of how our system during the video and audio conversion step 200 converts the video, audio and data into blocks of associated data 299. In more detail and still referring to FIG. 12 are shown a representation of a sequence of Audio Markers and Voice Annotations in an audio file 250. Audio marker 128 is presented as an “M” for marker inside the audio file 250. The voice annotation is presented as a “V” in the same audio file. There is also shown all the recorded scenes 233 and other data 220 as well as the process of sending this block of associated data 299 to the systems database 480.

### Image Detection 300

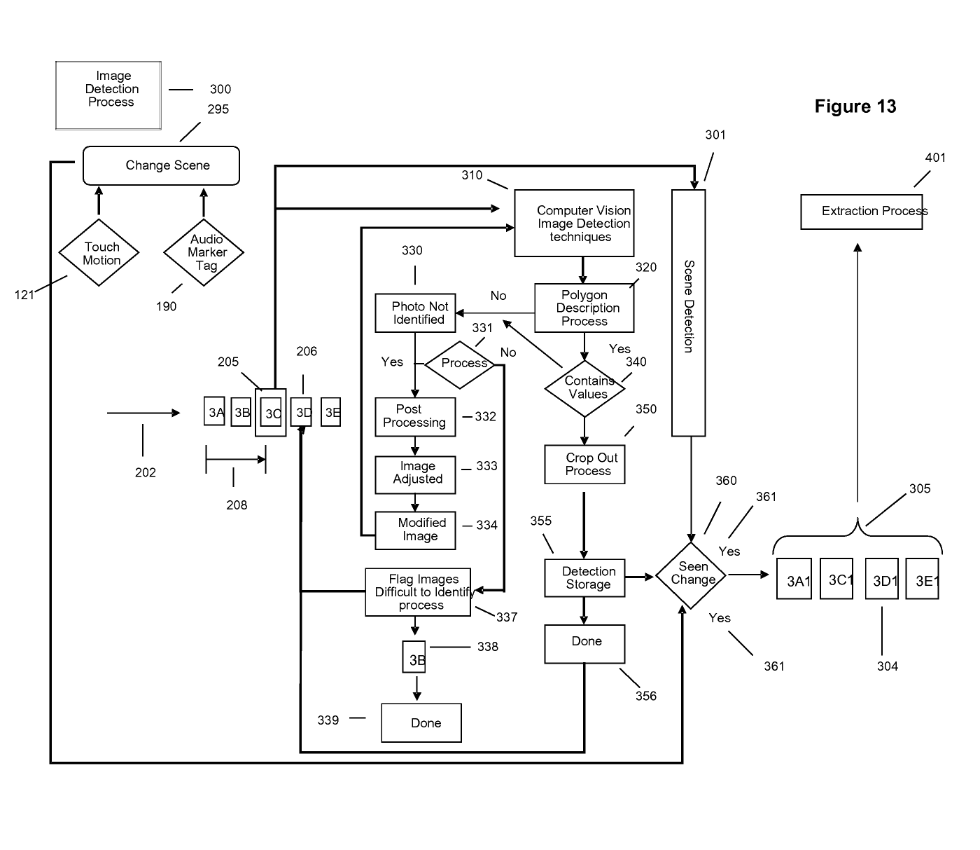

In more detail and referring to FIG. 13 there is shown as part of Image Detection 300 the following components: touch motion 121 to trigger for a scene change, and audio marker tags 190 to trigger a scene change and change scene 295. Still referring to FIG. 13 there is also shown the computer vision image detection techniques 310 and the polygon description process 320.

In more detail and still referring to FIG. 13 there is shown as part of Image Detection 300 the following components. Photo Not Identified 330, Post Processing 332, a modified image 334. When Image Detection 300 fails, the image goes through an image adjusted 333 step to improve the chances of detection and is converted into a modified image 334. Also shown are flagged image difficult to identify 337 and the images not identified 338.

In more detail and still referring to FIG. 13 there is shown as part of Image Detection 300 the following components: crop out process 350, scene detection 301, scene change 360, “Yes” value 361 that indicates that a scene change 360 has occurred. detection storage 355, done 356, new identified image 304 illustrated as “3A1” the identified array of photograph images 305 illustrated in the FIG. 3A1, 3C1, 3D1, 3E1 to denote images that have been identified by the system during the image detection process 300 that correspond with video image frame “3A, 3C, 3D, 3E” and will be ready to move to the extraction process 401 once a scene change is triggered in the system.

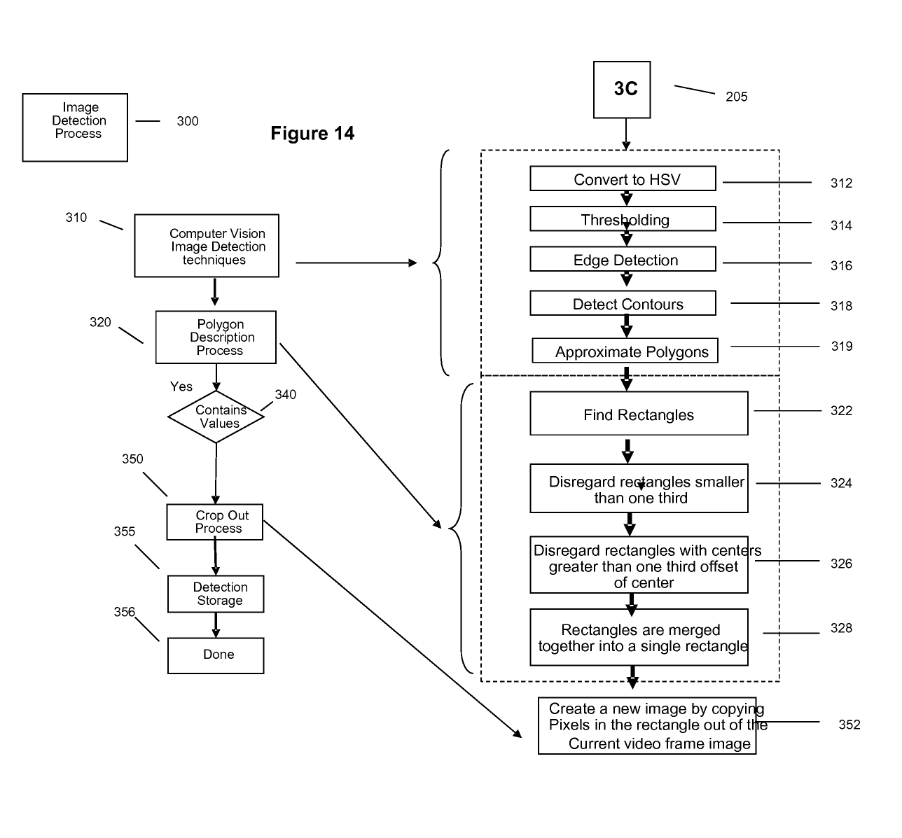

In more details and still referring to the Image Detection Process 300 there is shown in FIG. 14 a detailed view of the computer vision and image detection process 310, polygon description process 320 and crop out process 350. FIG. 13 contains the following components: current video frame image 205, convert to HSV 312, threshold 314, edge detection 316, detect contours 318, approximate polygon 319. In more detail and referring to polygon description 320 there is shown the following components find rectangles 322, disregard rectangles smaller than one third of size of the current video frame image 324, disregards rectangles with centers greater than one third offset of center of the size of the current video frame image 326. Still referring to FIG. 13 there is also shown in more details as part of the crop out process 350 the following component: create a new image by copying pixels in the rectangle out of the current video frame image 352.

### Extraction and Association Process 400

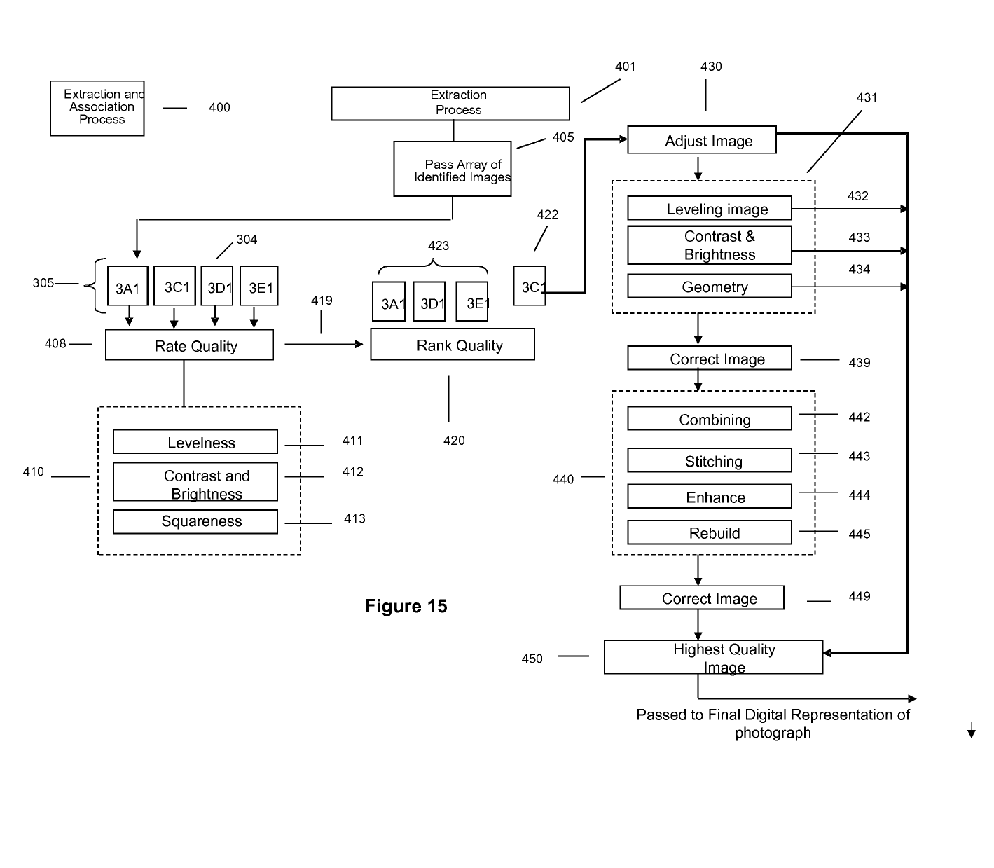

In FIG. 15 as part of Extraction and Association Process 400 there is shown the input to the extraction process 401, the action of passing 405 the identified array of photograph images 305 to the rate quality process 408. This rate quality process in our system involves the use of known image quality rating techniques 410 including, but not limited to determining levelness, 411, contrast and brightness 412 and squareness 413 of the identified array of images.

Still referring to FIG. 15 and in more detail once the images are rated they are passed to a rank quality step 420 in our system to rank the images in highest order. The rank quality 420 step produces the single highest ranked image 422 shown in FIG. 15 as “3C1” to be sent do the adjust image step 430. The remaining array of identified images 423 are used to enhance the visual appearance and to correct defects within the highest ranked image 422.

Still referring to FIG. 15 and in more detail in our system the adjust image step 430 is comprised of both basic image adjustment techniques 431 including but not limited to leveling image 432, improving contrast and brightness 433, and improving geometry 434 of the highest ranked image 422 and as well as being comprised of more complex image adjustment techniques 440. These more complex image adjustment techniques include combining 442, stitching 443, enhancing 444, rebuilding 445 and correcting the highest ranked image 422 illustrated in FIG. 15 as “3C1” by using sections of the remaining array of identified images 423 in order to arrive at the highest quality image 450.

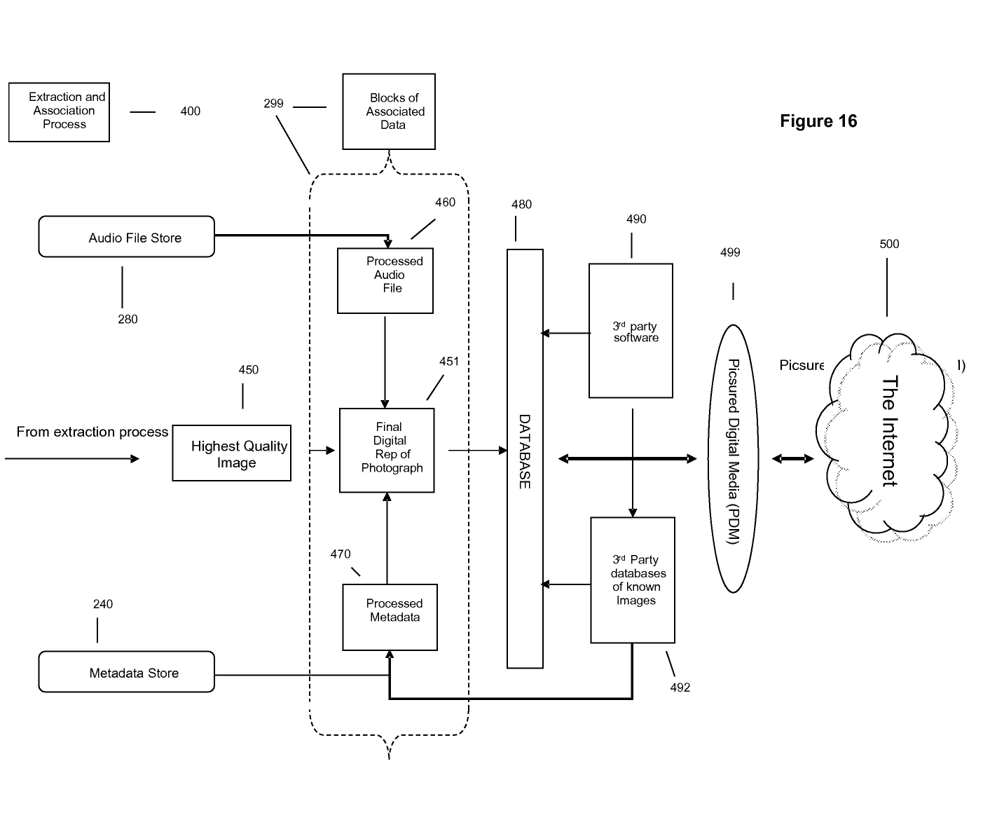

In more detail and still referring to the Extraction and Association Process 400 is FIG. 16 which shows the following components: audio file store 280, metadata store 240, and the highest quality image 450. In more detail and still referring to FIG. 16 there is shown a final digital representation of the photograph 451. There is also shown the processed audio file 460 and processed metadata associated 470 that is associated with the final digital representation of the photograph 451 and there is shown a block of associated data 299, the system's database 480, 3^{rd} party software 490 such as image recognition software or optical character recognition software, 3^{rd} party database of known images 492, a Picsured Digital Media file 499, and the Internet 500.

### EXPLANATION OF EMBODIMENT(S) OF USING OUR INVENTION

### Step 100—Video, Audio and Data Capture

Referring to FIG. 2 the Video, Audio and Data Capture process 100 involves capturing any group of photograph images 101 that is reside on any visual surface 103. The process entails a person with the ability to turn on 113, hold, and move any number of video and audio recording devices 109 across a group of photograph images 101 from M1 Start to M2 finish the video recording motion 108. When using our system there is no need to remove the group of photograph image 101 from the visual surface 103 that they are on such as a photograph album, or any other display holding the group of photograph images 101.

Referring to FIG. 3 any one skilled in using a video camera should be able to record a photograph image 102 using our system. The process includes ensuring that the photograph image 102 is captured in the view finder 110, 111, 112 for enough time by the video and audio recording device 109 so that the recording device can create a complete video copy of the photograph image 102.

A complete video copy means filming the image the photograph image 102 in a scene 115 at a high enough shutter speed and with sufficient lighting to create a minimally blurred, visually clear, digital representation for a minimum of one video frame from each scene 115. A scene is defined as the entire visual environment being captured by a single video frame. In actuality, with commonly available capture devices, the user will want to film the image or images in a scene 115 for a time of at least 1 second per scene 115 with minimal movement, which depending on the capture device, would result in anywhere from 24-60 digital representations in the form of video frames of each image. This step is highly dependent on the quality of the video and audio capture device 109 and the sophistication of the user, and the scenario we just described is intended to represent the average user's experience.

Still referring to FIG. 3 the video recording process should be performed in a way to ensure that as many outer border vertices 114 of the photograph image 102 are captured during the recording process. It is useful when all four vertices 114 of the photograph image 102 are captured inside the video and audio recording device's 109 view finder 110, 111, 112 before moving to the next photograph. However our system does not rely on capturing all four vertices and can still complete the process even if no vertices have been captured.

In additional embodiments our system can use other known techniques to look for people. One example of another known computer vision image detection technique 310 involves centering a polygon around areas of interest such as people or buildings.

In addition and referring to FIG. 4 while recording the said photograph image with a video and audio recording device 109 one can record a voice annotation 137 describing specific information about the said photograph or photographs being video recorded. This voice annotation 137 can be created by speaking into the audio speaker 116 when the view finder 111 is placed over the photograph image 102 or images and the video and audio recording device is turned on. These voice annotation will be captured and stored in an audio file in relation to the captured video recording of the photograph image 102 or images.

In more detail and referring to FIG. 5 there is shown multiple photograph images in one scene 118 captured in the touch sensitive computer tablet view finder 111. Our system is able to capture and convert multiple photograph images 102 in one scene 118 using the same methods we use for capturing a single photograph image 102 per video recorded scene.

### Touch Motion—

In more detail and referring to FIG. 6 during the Video and Audio Capture 100 step there is shown another embodiment of the audio and video capture process using our invention. This additional embodiment includes using our invention as an application that runs within a touch screen sensitive device such as a touch sensitive computer tablet 105 or touch sensitive smartphone 106.

As shown in FIG. 6, our invention includes the ability when using a touch screen sensitive device 105 to be able to use a touch motion with a single or group of fingers and/or thumb 122 on the selected image on the touch screen sensitive computer tablet 105 screen and view finder 111, to select and tell our system to video capture the photographic image 102 before moving to the next image.

### Swipe Motion

In more detail and still referring to FIG. 6 our system's embodiment(s) use a swipe motion 122 which entails using a touch sensitive device such as a computer tablet 105 and moving it 120 over the photographic image 102 so that the user see all outer four vertices 114 in the view finder 111 of the photograph image 102. Then use a finger swipe motion 122 across the photograph image 102 that is visible in the view finder. This finger swiping motion 122 entail running a finger across a sufficient portion of photograph to select the photographic image as shown from M1 Start to M2 Finish 124 before proceeding to the next photographic image 104. This swipe motion 122 can be diagonally across or straight across from one of the outer vertices to the other outer vertices on the opposite side of image. The swiping motion over-rides the default image detection capture and instead uses whatever has been swiped as the captured image.

### Other Touch Mode Embodiments

### Multi-Touch Mode

In more detail and still referring to FIG. 6 when a video and audio recording devices 109 support multi-touch, meaning, more than one touch on the screen simultaneously, our system will interpret the touching of two fingers to represent the M1 Start and M2 Finish positions 124,

### Partial Swipe Motion

In more detail and still referring to FIG. 6 in another embodiment there is a person's finger swiping only a portion 123 of the photograph image 102. Our system will capture any portion of a photograph image that is swiped and will run what is captured through the same image detection process 300.

### Always on Mode

In another embodiment and still referring to FIG. 6 our invention allows for the touch screen sensitive device 105 when the video record mode is turned on 113 to continuously capture images without the need to swipe any finger across an image.

### Touch-on Mode

In another embodiment and still referring to FIG. 6 our invention allows for the touch screen sensitive device such as a computer tablet 105 when the video record mode is ON to capture images without the need to swipe any finger across an image, when the user is touching the screen. The invention keeps capturing images as long as the user is touching the screen. The invention would not capture images once the user stops touching the screen.

### Audio Markers

In more detail and referring to FIG. 7 audio markers 128 can be added by a person when video recording a group of photograph images 101 to denote each time a person is moving to a new photograph image 102.

When our invention is being used in a software application that runs within a device such as a touch sensitive computer tablet 105 or smart phone 106 the application can be configured so that these audio markers 128 can be pre-selected by the individual in advance from within the software application. A person could select any word or sound to indicate they want to move to video record the next photograph image.

In more detail and still referring to FIG. 7 the system can capture a range of different types of audio marker 128 including spoken word, time period of silence or specific verbal noise to detect that a person wants to move to capture the next photograph image 104. When these audio markers 128 are captured the system performs the action of marking the specific point in time 189 within the video stream 202 and audio file 250 by leaving an audio marker tag 190 in the video file 170 associated with that specific point in time that represents a scene change 295.

In more detail and still referring to FIG. 7 when our invention is being used on a video recording device and is not embedded in a software application then individuals using our video and audio capture method can use a pre-programmed default term such as “DONE” to indicate to the system that they are moving to a new photograph. Each time the person is video recording a photograph image and says “DONE” before moving to the next image our system will recognize the audio marker 128 which will tell the system that the person is done with the current photographic image 102 and confirms that the person wants to move to video and audio record the next photographic image 104.

### Audio Annotating Specific Areas of Interest on a Photograph

During the Video, Audio and Data Capture process 100 another embodiment of our invention is shown in FIG. 8. This additional embodiment involves using a touch screen sensitive device such as a computer tablet 105. A person can point and touch 133 a specific area on the computer tablet's 105 screen and view finder 111 to identify and describe a specific point of interest 134 in the photograph. Through the use of voice annotation that is captured by our system at the time that the person touches 133 the specific point of interest 134 on the screen and view finder 111 our invention allows someone to describe that specific points of interest 134 on the photograph through a voice annotation 137 that is captured in the system and becomes related to the exact coordinates 135 where the subject of interest resides in the photograph.

As demonstrated in FIG. 8, our invention enables this unique voice annotation of specific points of interest 134 along with the coordinates 135 on the photographic image 102 where the person touched the view finder 111 to be stored and associated with the digital representation of the photograph in the systems database.

FIG. 8 provides an example of a situation where a person is looking at a photograph of family relatives and the person video recording the photographic image using our system wants to points out one relative in particular who is the specific point of interest 134, the person may want to explain something about that person through a voice annotation 137 which is then captured and associated precisely with the coordinates 135 on the photograph image where that particular family relative being described is located in the view finder 111. This information later can be left in audio format or be converted into a text format through any number of standard voice-to-text translation engines and then can be stored as text or audio format in association with the specific coordinates of that that one family relative.

### Summary of Video and Audio Capture

In general our invention works with any video file 170 that has been created by anyone using a standard video and audio recording device. In a most basic embodiment anyone can make a video recording of a group of photographs 101 and then upload the video recording to our system which resides on an external server. Then our system will process the video file. A person can use our system without needing to place audio markers. Placing audio markers represents only one embodiment of the invention. Further, a person can use our system and leave no voice annotations. The ability to create voice annotations is simply one novel option of our invention. Furthermore a person can video record a group of photograph images 101 and store them on an external device and then at some later date upload them to our system to be processed. Our system can also work as a software application that resides on any number of devices such as smart phones, tablet computer, or other types of devices that contain a video and audio recording device.

### Step 200—Video and Audio Conversion

In more detail and referring to FIG. 9 as part of Video, Audio and Data Conversion 200 the system receives as its input the current video frame image of the same scene 205 from the video data file 170 which is delivered into the video and audio conversion process 200 as part of a video stream 202. Once the current video frame image 205 runs through the entire system, the next video frame image 206 will be converted and so on based on the sequence of images 208 that is contained in the video stream 202.

In addition as shown in FIG. 10 the system extracts an audio file 250 from the video data file 170 and identifies any processed voice annotation 137 that was created during the video recording of a photograph image 102 and places it in an audio store 280 in both an audio file format and as text that has been converted from the audio file through a standard voice-to-text conversion program. The system also extracts the audio marker tags 190 from the video data file 170 captured and associated by the system with current video frame image 205. The system then uses the audio marker 190 to denote if a change scene 295

In addition and referring to FIG. 11 as part of the Video, Audio and Data Conversion 200 the system extracts other data 220 from the video data file 170. These data types include, but are not limited to “derived data” 225 which includes any data that can be retrieved from processing the image including, but not limited to vector fields, histograms, sharpness, text, data and time stamps. Metadata 230, including metadata related to time includes time offsets or frame numbers. The system also extracts any device data 235, which includes but is not limited to data that is generated from any software or hardware that is running on the device at the time of video recording such as data related to the devices touch screen capabilities, device accelerometers, or device GPS related data. This also would include any data that is generated by a separate device that is gathering information that is to be associated with the video data. Four example a user can add a narrative from a pre-existing audio recording through the use of an external audio recording device or a microphone attached to their computer. Our invention will capture the external audio recording in sequence with the video recording and perform the action of marking specific points in time 189 that associate a specific section of external audio recording with the current video frame image 205 that were recorded at the same time.

These various types of data: derived data 335, metadata for time 330 and device data 340 are then passed through to metadata store 240.

As illustrated in FIG. 12 the system looks for audio marker tags 190 in the audio file 250. If these audio marker tags are present, the system can use these audio market tags to associate any voice annotation represented by “V” that may been created during a specific video scene 115 and associate it with specific data such a device data 235 captured between two audio markers. As illustrated in FIG. 12 the system creates a block of associated data 299 comprised of audio, video and other data. The degree to which this audio, video and other data is associated is captured and stored within the system's database. By doing this our system preserves a sequence of events that serve to replicate the interaction between a person and a photograph during the Video, Audio and Data Capture Process 100.

### Step 300—Image Detection

In more detail and referring to FIG. 13 Image detection 300 the system receives as its input the current video frame image 205 from the video stream 202. The conversion of the video stream 202 into a sequence of images 208 is considered to be common knowledge within the realm of computer vision. The sequence of images 208 are passed through the system's computer vision image detection techniques 310. By using and combining various computer vision image detection techniques 310 one trained in the art of computer vision can use the invention to resolve corrupted data from factors such as lighting, reflection, and movement to identify a photographic image from within current video frame image 205.

### Image Not Identified

In more detail and referring now to FIG. 13 if the computer vision image detection process 310 does not identify any polygons that approximate the photographic image then the polygon description process 320 will be empty and Image Detection 300 will move the current video frame image 205 to the photo not identified 330. The post processing 332 takes as its input the current video frame image 205 that has not been identified. The current video frame image 205 goes through an image adjusted 333 step to improve the chances of detection and the output is a modified image 334. Then the system passes the modified image 334 back again through the computer vision image detection techniques 310. The system allows this process to continue as long as required in order to detect successfully, however in actuality the system limits of time require a detect-adjust-detect routine to be run only a limited number of times per current video frame image 205 not detected. This allows the system to give a modified video frame image 334 the best-shot at detection. The system will move to the next video frame image of the same scene 206 when the attempt fails multiple times.

If after reprocessing multiple times without success the system places the modified image 334 into the flagged image difficult to identify process 337 and the images not identified 338 are stored for return to the user.

### Photo Identified

In FIG. 14 we present just one of many options in using computer vision image detection techniques 310. In this one example any number of standard image manipulation techniques such as converting to HSV 312, thresholding 314, edge detection 316, detect contours 318 to arrive at a number of approximate polygon 319 detected in each current video frame image 205.

In more detail and still referring to FIG. 13 the computer vision image techniques 310 work on identifying polygons that might represent the photograph image contained within the current video frame image 205 being processed. The result is often multiple approximate polygons from each video frame image 205. The system will then pass these multiple polygons to the polygon description process 320. The multiple polygons are passed as an array of numerical representations of the detected polygons usually in the form of a set of x,y coordinates that represent the shape polygon contained within the image, where each entry in the array represents a detected polygon.

In more detail and still referring to FIG. 14 we continue to illustrate one of many options of using computer vision image detection techniques 310. In this example during the polygon description process 320 the system iterates through the array of polygons and looks to find ones that approximate rectangles by finding rectangles in each plane 322. It does this by comparing the angles of each 3 x,y coordinates in order. Identified rectangles are then processed heuristically (guideline or estimation) for minimum acceptability—for example by discarding rectangles smaller than one third 324 of the size of the current video frame image 205 and discarding rectangles with the centers greater than one third the offset of center 326 of the current video frame image 205. Finally, the accepted rectangles are merged together into a single rectangle 328 by taking the minimum 2 dimensional bounding box of the accepted polygon regions. The final polygon represents the systems recognition of the photographic image in the frame, and is not modified visually at this point. The result will be a single polygon to crop out of the current video frame image. Once a rectangle is identified the image in the scene is then passed along with the polygon coordinates to the crop out process 350. The crop out process 350 creates a new identified image 304 by copying the pixels in the polygon 352 out of the current video frame image 205. The new identified image 304 is then moved to detection storage 355. If at the same time the system has detected a scene change the system passes all the new identified images illustrated in FIG. 13 as the identified array of images 305 from detection storage 355 to the extraction process 401.

Our system is able to determine if a scene has changed and an individual has moved to video record a new photograph. The system accomplishes this by detecting changes in certain characteristics such lighting, motion, touch, sound or visual cues such a waving hand or turning a page. The system can detect changes in any number of characteristics at the same time. For example, the system can calculate the degree of motion between two video frames the current and the prior video frame sequentially and additionally compare the difference in characteristics between the two frames such as lighting using standard computer vision techniques that determine regions of similarity.

The system's change scene 295 detection process involves two general approaches. One approach to detect a scene change entails pre-processing the sequence of images 208 at the beginning of the image detection 300 process and gathering statistical data related of characteristics of each video frame image that can later be used to determine if a scene change has taken place and the individual has moved to a new photograph or not. An additional approach involves processing the sequence of images 208 during the image detection 300 process, saving and comparing characteristics from the prior video frame image to the current video frame image.

In one embodiment our system pre-processes the sequence of images 208 at the beginning of the image detection 300 process in order to reduce the load on the system during image detection. When our system pre-processes the sequences of images 208 at the beginning of image detection 300 process the system can calculate in advance an optimum threshold to trigger a scene change and in addition the system can create referential data that will allow the system to determine if a user has moved to a photograph that they have already captured so that the system will know if they have moved back to the previous photograph.

### Summary of Image Detection

The computer vision image detection process 310 can contain a number of standard computer vision image manipulation techniques such as thresholding, edge detection, histogram-based methods, color separation, to name a few. In one embodiment, which is just one example of how to use computer vision image detection techniques our system separates colors and runs a variable thresholding algorithm on each color, detects edges, and recombines the colors into an image that is then processed again through the computer vision image detection techniques. Additionally, in this example of one embodiment of use of computer vision image detection in our system, the system uses logic that selects certain image manipulation techniques based on characteristics of the input image, or based on success/failure of the image detection routines previously performed for the previous images. This allows the computer image detection process to improve accuracy over time.

Furthermore our system is also able to continue to function with involvement human activity to augment or complete the following during the image detection process 300: scene detection 301, post processing 332, image adjusted 333, flag image difficult to identify process 337, crop out process 350, extraction process 401.

### Step 400—Extraction and Association Process

In more detail and referring to FIG. 15 is the Extraction and Association Process 400. The extraction process 401 takes as its input the identified array of images 305. The extraction process refers to the process of rate quality 408, rank quality 430 and adjust image 430. The output is a single image that is considered the highest quality image 450.

### Rating Quality

In more detail and referring to FIG. 15 during the extraction process 401 when there is more than one image that has been extracted during the image detection process 300 the system will rate the quality 408 of the identified array of images 305 based on rate quality techniques 410 including, but not limited to the image's degree levelness 411, brightness 413, and squareness 413. The rate quality 408 step is based on identifying the image with the least amount of visual geometric distortion, highest resolution of the identified array of images 305, and possesses balanced contrast, color, and brightness. Next the system performs the action of passing 419 the now rated identified array of images 305 to the rank quality step 420 process.

### Ranking Quality

In more detail and still referring to the rank quality 420 process in FIG. 15 the system ranks and creates the preferred order of highest to lowest ranking of the identified array of images 305. During this rank quality process 420 the system identifies which of the new identified images 305 has the highest probability of containing the entire physical photograph image 102. The system does this by identifying the same features across all of the identified array of images 305 from the same scene 115. The system then compares which of the image has the greatest overlap across all the identified array of images 305 and greatest likelihood of a concentration of features that might represent the features of the highest quality image. The system then deduces that this will be the image that will likely be the one with the highest probability of best representing the photograph image 102 that the system is trying to digitize from the given scene. The output of this rank quality 420 process is what is called the single highest ranked image 422. The system then passes the ranked highest image 422 to the adjust image 430 step.

It is noted that the order of operations illustrated in FIGS. 13-15 are not the only order in which the operations may be performed. The specific sequence of operation (including multiple uses of one operation) change according to the embodiment employed.

### Adjust Image

In more detail and referring to FIG. 15 the system conducts an adjust image 430 step on the ranked highest image 422. The adjust image 430 process contains both basic adjustments 431 which include using known standard image adjustment techniques. In addition the system performs complex adjustments techniques 440 which are proprietary combinations of basic and more complex image adjustments techniques.

The basic adjustment 431 techniques include, but not limited to improving the levelness of the image 432, improve contrast and brightness 433 and improve the image's geometry 434. Then the system corrects the image 439. The system at anytime can pass the image do the highest quality image 450.

In addition the system can use, though not required a series of more complex adjustment techniques 440 to further adjust the highest quality image 450. These more complex adjustment techniques 440 include, but are not limited to combining 443 the same sections various sections of an image, stitching 443 and enhancing 444. Combining 443 various sections means extracting the same particular section from the highest ranked image 422 illustrated in FIG. 15 as “3C1” that exists in the remaining identified array of images 323 to create the highest possible quality copy of that particular section for that image. Then the system uses additional complex adjustment techniques 440 such as stitching 443 to stitch the various highest quality sections together, and then enhance 445 and rebuild 445 the image to arrive at single highest quality image 450 from the identified array of images 305 that were derived by the system at any one point in time. Once the highest quality image 450 is created it is presented in the Extraction and Association Process as the final digital representation of the mage 451.

In more detail and still referring to Extraction and Association Process 400 as illustrated in FIG. 16 our system extracts a final digital representation of photograph 451 from the highest quality image 450. In addition our system extracts the processed audio file 460 from the audio file store 280 and the processed metadata 470 from the metadata store 240 that is associated and was captured by our system when the current video image frame 205 was created. This block of associated data 299 is comprised of the processed audio file 460, the final digital representation of the photograph and the processed metadata associated with current video frame image 205 at the time of with the original video and audio recording. This block of associated data 299 is stored in the system's database 480.

### Creating Picsured Digital Media (PDM) (Broadest Embodiment)

In more detail and still referring to FIG. 16 is a block of associated data 299 that is associated with the final digital representation of the photograph 451 created by the invention. This block of associated data 299 creates a Picsured Digital Media file 499 for each final digital representation of the photograph 451.

The Picsured Digital Medial file may contain, but does not have to contain data from the processed audio file 460 such as text data converted from a voice annotation, data from the processed metadata 470 associated with current video frame image 205 at the time of with the original video and audio recording was created such as location based data and 3^{rd} party data such as data derived from external 3^{rd} party database of known images 492 that can be associated with the final digital representation of the photograph when would for example be developed by using 3^{rd} party software 490 such as image recognition or optical character recognition software.

The Picsured Digital Media file 499 can be shared in any number of ways over the Internet 500. The Picsured Digital Media file 499 can be shared with or without audio to text annotations converted from the voice annotation that may have been created during the video recording of the photographic image.

In more detail and still referring to FIG. 16 once the system can enhance the final digital representation of the photograph 451 Picsured Digital Media file with 3^{rd} party data. One example is the system can use known third party software 490 and 3^{rd} party databases of known images 492 to identify recognizable data that exists in the final digital representation of the image 451 This data may include known names, street address, famous building images and shapes from 3^{rd} party databases that can be cross referenced with the block of associated data 299 in our database.

Furthermore our system allows for multiple people to share and voice annotate the final digital representation of the image 451 to further enhance the Picsured Digital Media file (PDM) 499 related to the photograph. For example, once the final digital representation of the photograph is shared, anyone can use a touch screen sensitive device with audio recording capabilities such as a touch sensitive computer tablet 105 that is running our system within an application to add additional voice annotations to the final digital representation of the photograph. These new voice annotations will be associated with the Picsured Digital Media file in the system's database 480 and also be associated with the block of associated data related to that photograph image.

One example is a situation where a couple uses the invention to digitize a group of photograph images 101 inside an old photo album. In this example, the photographs happen to be from a trip to Las Vegas during the grand opening up the Las Vegas Hilton in 1958 and the photographs are taken in front of a sign that say Las Vegas Hilton. When our system or a third party service using our system along with 3^{rd} party image recognition software 490 and 3^{rd} party databases of known images 492 the system can present new promotions and information about special weekend package for the newly renovated Las Vegas Hilton. This will be accomplished by the 3^{rd} party software having recognized the famous Las Vegas Hilton sign as an image or using other 3^{rd} party software the system such as optical character recognition could recognize the words “Las Vegas Hilton” contained in the final digital representation of the photograph.

In such an example there is the ability with the right consumer permission for a service to access the block of associated data 299, and the services references voice annotations which have been translated to text data, read the phrase “Las Vegas Hilton”—and then could present advertisers the ability share the timely and relevant offers to anyone viewing the Picsured Digital Media file 499 in service.

Once these photographs are converted to the final digital representation of the photograph 451 the individuals who use the system can access and share either just the photograph image or the entire Picsured Digital Medial 499 of each photograph with other family members via email, online photo albums, through social media sites or through our system that is running in an application.

Then the individuals who have received or gain access to the photograph image or the Picsured Digital Media file can use a touch screen sensitive application touch listen to the original voice annotations or scroll over the said XY Coordinates 135 related to a specific point of interest 134 to read the text version of the voice annotation that is created by our system.

In an additional embodiment, individuals viewing a PDM can use simple voice commands that can be pre-programmed in conjunction with touching the PDM with a touch sensitive screen tablet 105. These voice commands can include statements such as “Who is This?”, “What is this?”, “Where is this?”, etc to hear the voice annotation created by the person 131.

### ADVANTAGES OF THE INVENTION

The advantages of the current invention is that it requires only the use of a video recording device, a person reasonably trained with the ability to hold and move the camera across a group of photographs. This invention allows a person to capture photographs from any number of locations where a group of photographs images exist as long as they can be video recorded by a video recording device.

There is no need to remove the photographs from a photo album, or any other display or apparatus containing the photographic image 102. There is no need for the person to use any scanning equipment. Furthermore our system captures information relevant to the photographic image by being able to capture voice annotations 137 that were created when video recording the photograph and other relevant data related to photograph image. By capturing, processing and associating this block audio and other data with the original photographic image 102 our system not only converts and preserves the photograph image as a digital copy, but also captures the interaction and valuable insights and information that may be created and associated with the photograph image at the time of video and audio recording the photograph image.

While the above written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### LIST OF REFERENCES

100 Video and Audio Capture
200 Video and Audio Conversion
300 Image detection
400 Extraction process
101 Group of Photograph Images
102 Photograph Image
103 Any Visual Surface
104 Next photograph Image
105 Touch sensitive computer tablet
106 Touch or non Touch sensitive smart phone
107 Video Camera
108 M1 Start to M2 Finish Video Recording Motion
109 Any number of Video and Audio Recording Devices
110 Video Camera View Finder
111 Touch sensitive computer tablet screen and view finder
112 Touch sensitive smart phone screen and view finder
113 Turned ON
114 Images Four Outer Vertices
115 A Scene
116 Audio Recording Device
118 Multiple Photograph images in one scene
119 Multiple Video frame Images from the Same Scene
120 Movement
121 Touch Motion
122 Finger Swipe Motion diagonally across entire photograph
123 Finger Swiping a portion of photograph
124 M1 Start to M2 Finish Swiping motion
128 Audio Markers
130 Graphic Representation of the Photograph Image 102
131 a person
134 Specific Point of Interest
135 XY Coordinates
136 Speaking
137 Voice Annotation
139 Action of Placing
142 Voice Annotation Data Store
170 Video Data File
172 Upload Process
174 Process of Storing Video
180 Server (Server reference still need to be illustrated somewhere in the one of the figures)
182 External Storage Device
189 Action of marking a specific point in time
190 Audio Marker Tag
202 Video Stream
204 Prior Video Frame Image of the same scene
205 Current Video Frame Image of the same scene
206 Next Video Frame Image of the same scene
208 Sequence of Images
220 Other Data
225 Derived Data
230 Metadata
233 All the video frame images for a particular scene
235 Device Data
240 Metadata Store
250 Audio File
255 Processed voice annotation
280 Audio File Store
290 Audio Marker Tags
295 Change scene process
299 Blocks of Associated data
301 Scene Detection
304 New Identified Image
305 Identified Array of Photograph Images
310 Computer Vision Image Detection Techniques
312 Converting to HSV
314 Thresholding
316 Edge Detection
318 Detect Contours
319 Approximate Polygons
320 Polygon Description Process
322 Finding Rectangles in each plane
323 Remaining identified array of images
324 Discarding rectangles smaller than one third of the size of the current video frame image
326 Discarding rectangles with centers greater than one third of the size of the current video frame image
328 Merged together into a single rectangle
330 Photo Not Identified
332 Post Processing
334 Modified Image
337 Flagged Image difficult to identify
338 Images Not Identified
350 Crop Out Process
352 Create a new image by copying the pixels in the polygon out of the current video frame image
355 Detection Storage
360 Scene Change
361 Yes—Validation that a scene has changed
365 DONE
401 Extraction Process
405 Pass multiple images
408 Rate Quality Process
410 Known Image Quality Rating Techniques
411 Levelness
412 Contrast and Brightness
413 Squareness
419 Action of Passing
420 Rank Quality Process
422 Highest Ranked Image
423 Remaining Array of Identified images
430 Adjust Image
431 Basic Image Adjustment Techniques
432 Leveling Image
433 Improving Contrast and Brightness
434 Improving the Geometry
439 Correct Image First Time
440 Complex Image Adjustment Techniques
442 Combining
443 Stitching
444 Enhancing
445 Rebuilding
449 Correct Image Second Time
450 Highest Quality Image
451 Final Digital Representation of Photograph
460 Processed Audio File
470 Processed Metadata
480 Database
490 3^{rd} Party Software
492 3^{rd} Party databases of known images
499 Picsured Digital Media file (PDM)
500 The Internet

### ADDITIONAL COMMENTS

### A. Overview

The advantages of the current invention is that it requires only the use of a video recording device, a person reasonably trained with the ability to hold and move the camera across a group of photographs. This invention allows someone to capture photographs from any number of locations where a group of photograph images exist as long as they can be video recorded by a video recording device.

There is no need to remove the photographs from a photo album, or any other display or apparatus containing the physical photographic image. There is no need for the person to use any scanning equipment. Furthermore our system captures information relevant to the photographic image by being able to capture voice annotations that were created when video recording the photograph and other relevant data related to photographic image. By creating this block of associated audio and data with the original photographic image our system not only digitizes and preserves what often will be physical photographic prints, but also captures the interaction and valuable insight and information that most often would be naturally created and shared through someone's voice annotation.

In general our invention works with any video file that has been created by anyone using a standard video and audio recording device where anyone can make a video recording of a group of photographs and then upload or pass the video recording to our system which can reside on an external server or locally on a client. An example of a local client would be a smart phone which would both create video recording as well process the file using our system. A person can use our system without needing to use audio markers to identify when they want to capture a photographic image. A person can use our system and leave no audio based voice annotations related to the photographic image. Furthermore a person can video record a group of photograph images and store them on an external device and then at some later date upload them to our system to be processed. Our system can work as a software application that resides on any number of local devices that act as a client such as but is not limited to: any common computing environment, a personal computer, computer server, a smart phone, a tablet computer, embedded in a video camera or embedded in an SLR camera or any embedded system.

### B. Additional Comments

1. Arrive at the Best Quality Digital Representation from Multiple Images

In order to arrive at a best quality digital representation of a physical photographic image our invention is able to leverage the fact that video creates multiple frames per second and this allows for our system to capture those multiple video frame images of the same photographic image when video recording. Our system is then able to sort through and rank the best video frame image to arrive and extract the single best digital representation of the original photographic image.

In addition, our system is able to arrive at the highest quality image by combining and stitching together multiple sections of the same video frame image from various video frame images that are captured by the system when video recording the said photographic image.

### 2. Dynamic Association of Audio, Video, and User Interaction Data Captured During the Digitization Process

The invention provides a unique way to incorporate multiple data points from the user experience simultaneously while the photo digitization process is takes place.

Our invention is unique because while recording a physical photographic image with a video and audio recording device one can record a voice annotation describing specific information about the said photograph while it is being video recorded. This voice annotation can be created by speaking into the audio speaker of the said device when the view finder is placed over the said photographic image and the recording device is turned on. These voice annotation will be captured and stored in an audio file in relation to the captured video recording of the photograph image

During the video and audio recording user interaction data is captured and is automatically associated with the final representative photograph image to create a unique interactive experience with multiple forms of visual and audio data that are associated with the photograph or certain points of interest in the photograph.

Our system is also unique in being able to capture and extract any device data generated from any software or hardware that is running on the device at the time of video recording including devices touch screen data and combining this data with the photograph image and audio image to capture and replicate the interaction between a person and the original photographic image.

The system creates a block of associated data comprised of audio, video and other data and the degree to which this audio, video and other data is associated the system captures this association and stores the association within the system relational database. By doing this our system is a unique way to preserves a sequence of events that replicate the interaction between a person and a photograph during the video and audio capture process. This data is contained in our system and associated with the original photographic image in the form of a Picsured Digital Media file.

### 3. Audio Markers

Our invention is a unique way to use audio markers by a person when video recording a group of photograph images to denote each time a person want to capture a photographic image and move to a new photograph image. These audio markers can be pre-selected by the individual in advance from within the software application. A person could select any word or sound to indicate they want capture and to move to the next photographic image. When these audio markers are captured the system performs the action of marking the specific point in time within the video stream and leaving an audio marker tag in the a said video file to represent a scene change. The system can capture a range of different types of audio markers including spoken word, time period of silence or specific verbal noise to detect that a person wants to move to capture a new photographic image.

An example. Each time the person is video recording a photograph image and says “DONE” before moving to the next image our system will recognize the audio marker which in turn will tell the system that the person is done, want to the capture the current photographic image and confirms that the person wants to move to the next image in order to video and audio record the next photographic image.

### 4. Swipe Motion to Capture and Move to Next Image

Our invention includes the ability when using a touch screen sensitive device to be able to use a swipe motion with an single or group of fingers or thumb over the selected image on the touch screen sensitive device to select and video capture the photographic image before moving to the next image.

This finger swiping motion entails running a finger across a sufficient portion of photograph to select it. This motion can be diagonally across or straight across from one of the outer vertices to the other outer vertices on the opposite side. A person can also swipe a portion of the photograph image as our system will capture any portion of a photograph image that is swiped and will run what is captured through the same image detection process.

### 5. Audio Annotation Specific Areas of Interest on a Photograph

Our invention allows anyone using a touch screen sensitive device such as a computer tablet to point and touch a specific area on the computer tablet's screen and view finder to identify and describe a specific point of interest in the photograph. Through the use of voice annotation that is captured by our system at the time that the person touches the specific point of interest on the view finder our invention allows someone to describe that specific points of interest on the photograph through a voice annotation that is captured in the system and related to the exact coordinates where the subject of interest resides in the photograph on the view finder. The device data from these touch point is then stored and associated with the digital representation of the photograph in the systems database.

An example. A person is looking at a photograph of family relatives and the person video recording the photographic image wants to point out one relative in particular who is the specific point of interest. The person may want to explain something about that person through a voice annotation which is then captured and associated precisely with the coordinates on the photograph image where that particular family relative being described is located in the view finder. This information later can be left in audio format or be converted into a text format through any number of standard voice-to-text translation engines and then can be stored as text or audio format in association with the specific coordinates of that that one family relative.

When the digital photograph is transferred or shared by various people using the same system that may reside on multiple smart phone, computer or table computer application of the system across the voice annotation or the text that has been derived from the voice annotation can be viewed or heard when any person views the now digital copy of the photograph and either scrolls across the digital copy of the specific section where that particular family relative is located on the digital copy of photograph or touches the very same section on the digital copy of the photograph using a touch screen sensitive device running the system.

### 6. Multiple People to Voice Annotate a Photograph Image

Our system allows for multiple people to share and voice annotate a photographic image by using a touch screen sensitive device such as a computer tablet that is running our system within an application to add additional voice annotations to the same digital photograph.

Finally in a further embodiment the additional people can continue to further voice annotate on the same digital photograph to add more context and information when viewing the digital copy of the original photograph print image, save and have the new added voice annotation and the touch screen coordinates continue to be associated with a given photographic image and accessible to multiple parties.

### 7. Ranking and Rating

The system is a unique method of rating and ranking an array of images as created by the system to determine to select an image that is most likely be the highest quality duplication of the original photograph image. The system creates the preferred order of highest to lowest ranking of the identified array of images. During this rank quality process the system identifies which photograph has the highest probability of containing the maximum number of equivalent attributes of the original physical photographic image. The system does this by using an array of images that are captured in the system and comparing and contrasting them to identify unique features within each of the captured array of images. The system then compares which of the image has the greatest overlap across all the captured images and greatest likelihood of a concentration of features that might represent the features of the highest quality image. The system then deduces that this image will likely be the one with the highest probability of representing the entire photographic image that we are trying to capture in the scene. The result of this process is a unique ability to produce the single highest ranked image through our rating system.

8. Retrieving Data from Photograph Via Voice Commands

Individuals can use simple voice commands that can be pre-programmed in conjunction with touching the digital copy of the photographic image with a touch sensitive screen tablet to listen to the voice annotations. These voice commands can include statements such as “Who is This?”, “What is this?”, “Where is this?”, etc to hear the original voice annotation created by the person.

### 9. Polygon Detection

The system is a novel method of identifying polygons that might represent the photograph image contained within a video frame image being processed by the system. The result is often multiple approximate polygons from each video frame image. The system will then pass these multiple polygons to the polygon description process. The multiple polygons are passed as an array of numerical representations of the detected polygons usually in the form of a set of x,y coordinates that represent the shape polygon contained within the image, where each entry in the array represents a detected polygon.

In this example during the polygon identification method the system iterates through the array of polygons and looks to find ones that approximate rectangles by finding rectangles in each plane. It does this by comparing the angles of each 3 x,y coordinates in order. Identified rectangles are then processed for minimum acceptability and discarding rectangles smaller than one third of the image and discarding rectangles with the centers greater than one third the offset of center. Finally, the accepted rectangles are merged together into a single rectangle by taking the minimum 2 dimensional bounding box of the accepted polygon regions. The final polygon represents the system's recognition of the photographic image in the frame, and is not modified visually at this point. The result will be a single polygon to crop out of the video frame.

Once a rectangle is identified the image in the scene is then passed along with the polygon coordinates to the crop out process. The crop out process creates a new image by copying the pixels in the polygon out of the original image. The image is then moved to detection storage for that particular captured scene.

### 10. Use of Motion and Image Comparison to Detect Scene Changes

Our system is able to determine if a scene has changed and an individual has moved to video record a new photograph. The system accomplishes this by detecting changes in certain characteristics such lighting, motion, touch, sound or visual cues such a waving hand or turning a page. The system can detect changes in any number of characteristics at the same time. For example, the system can calculate the degree of motion between two video frames the current and the prior video frame sequentially and additionally compare the difference in characteristics between the two frames such as lighting using standard computer vision techniques that determine regions of similarity.

The system's change scene detection process involves two general approaches. One approach entails pre-processing the sequence of images at the beginning of the image detection process and gathering statistical data related of characteristics of each video frame image that can later be used to determine if a scene change has taken place and the individual has moved to a new photograph or not. An additional approach involves processing the sequence of images during the image detection process, saving and comparing characteristics from the prior video frame image to the current video frame image.

In one embodiment our system pre-processes the sequence of images at the beginning of the image detection process in order to reduce the load on the system during image detection. When our system pre-processes the sequences of images at the beginning of the image detection process our system can calculate in advance an optimum threshold to trigger a scene change and in addition our system can create referential data that will allow the system to determine if a user has moved to a photograph that they have already captured so that the system will know if individual has moved back to the previous photograph.

### C. Additional Figures and Description

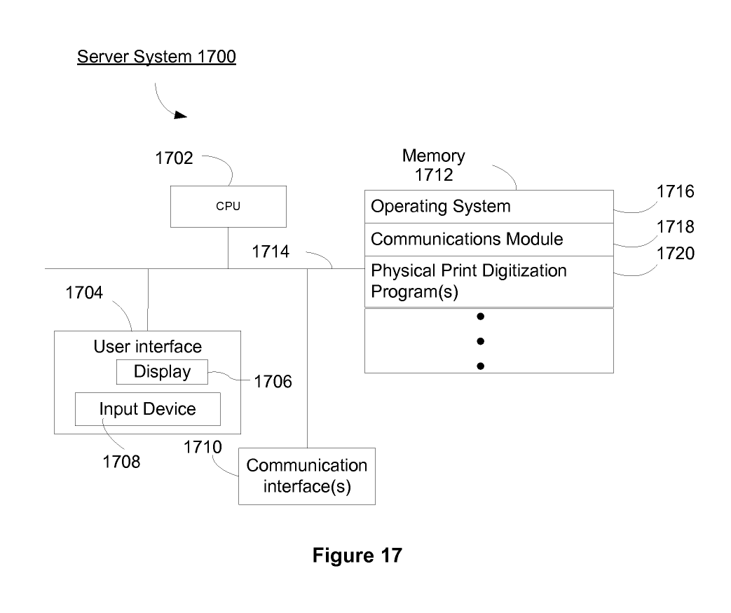

FIG. 17 is a block diagram illustrating a server system 1700 in accordance with some embodiments. The server system typically includes one or more processing units (CPU's) 1702, one or more network or other communications interfaces 1710, memory 1712, and one or more communication buses 1714 for interconnecting these components. The communication buses 1714 optionally include circuitry (sometimes called a chipset) that interconnects and controls communications between system components. The server system 1700 optionally includes a user interface 1704 comprising a display device 1706 and an input means such as a keyboard or touch sensitive screen 1708. Memory 1712 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1712 optionally includes one or more storage devices remotely located from the CPU(s) 302. Memory 312, or alternately the non-volatile memory device(s) within memory 1712, comprises a non-transitory computer readable storage medium. In some embodiments, memory 1712 or the computer readable storage medium of memory 1712 stores the following programs, modules and data structures, or a subset thereof:
an operating system 1716 that includes procedures for handling various basic system services and for performing hardware dependent tasks;
a network communication module 1718 that is used for connecting the server system 1700 to other computers via the one or more communication network interfaces 1710 (wired or wireless) and one or more communication networks, such as the Internet, other wide area networks, local area networks, metropolitan area networks, and so on;
a physical print digitization program (or group of programs) which perform the processes of producing a final digital representation of a physical print as described in detail with respect to the previous and subsequent figures.

Each of the above identified elements is typically stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 1712 stores a subset of the modules and data structures identified above. Furthermore, memory 1712 may store additional modules and data structures not described above.

Although FIG. 17 shows a “server system 1700,” FIG. 17 is intended more as functional description of various features present in a set of servers than as a structural schematic of the embodiments described herein. In practice, and as recognized by those of ordinary skill in the art, items shown separately could be combined and some items could be separated. For example, some items shown separately in FIG. 17 could be implemented on single servers and single items could be implemented by one or more servers. The actual number of servers used to implement the process of producing a final digital representation of a physical print and how features are allocated among them will vary from one implementation to another.

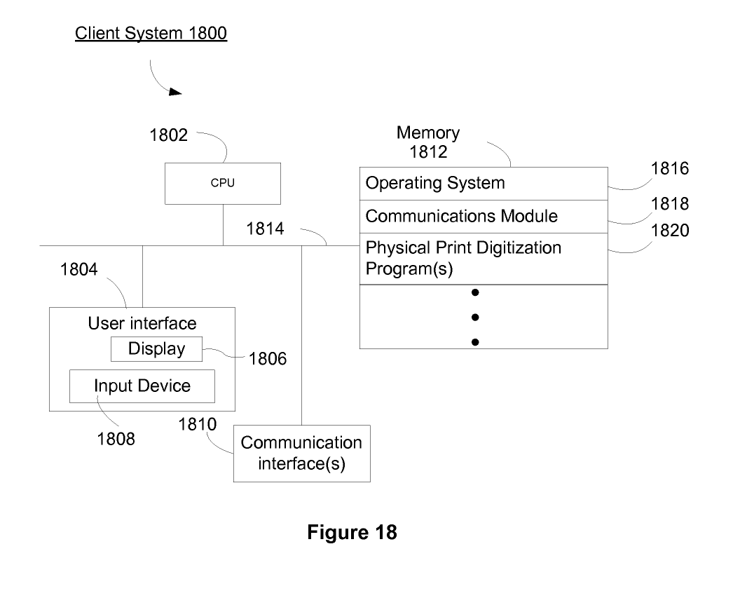

FIG. 18 is a block diagram illustrating a client system 1800 in accordance with some embodiments. In some embodiments, the client system is a personal computer, a smart phone, or a tablet computer. The client system typically includes one or more processing units (CPU's) 1802, one or more network or other communications interfaces 1810, memory 1812, and one or more communication buses 1814 for interconnecting these components. The communication buses 1814 optionally include circuitry (sometimes called a chipset) that interconnects and controls communications between system components. The client system 1800 optionally includes a user interface 1804 comprising a display device 1806 and an input means such as a keyboard or touch sensitive screen 1808. Memory 1812 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1812 optionally includes one or more storage devices remotely located from the CPU(s) 302. Memory 1812, or alternately the non-volatile memory device(s) within memory 1812, comprises a non-transitory computer readable storage medium. In some embodiments, memory 1812 or the computer readable storage medium of memory 1812 stores the following programs, modules and data structures, or a subset thereof:
an operating system 1816 that includes procedures for handling various basic system services and for performing hardware dependent tasks;
a network communication module 1818 that is used for connecting the client system 1800 to other computers via the one or more communication network interfaces 1810 (wired or wireless) and one or more communication networks, such as the Internet, other wide area networks, local area networks, metropolitan area networks, and so on;
a physical print digitization program (or group of programs) 1820 which perform the processes of producing a final digital representation of a physical print as described in detail with respect to the previous and subsequent figures. In some embodiments the process of producing a final digital representation of a physical print is performed entirely on the client system 1800, which in other embodiments, the client system 1800 works in conjunction with the server system 1700 to perform the claimed process. Both embodiments are explained in more detail with respect to the previous figures.

Each of the above identified elements is typically stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 1812 stores a subset of the modules and data structures identified above. Furthermore, memory 1812 may store additional modules and data structures not described above.

Although FIG. 18 shows a “client system 1800,” FIG. 18 is intended more as functional description of various features present in a set of servers than as a structural schematic of the embodiments described herein. In practice, and as recognized by those of ordinary skill in the art, items shown separately could be combined and some items could be separated. For example, some items shown separately in FIG. 18 could be implemented on single servers and single items could be implemented by one or more servers. The actual number of servers used to implement the process of producing a final digital representation of a physical print and how features are allocated among them will vary from one implementation to another.

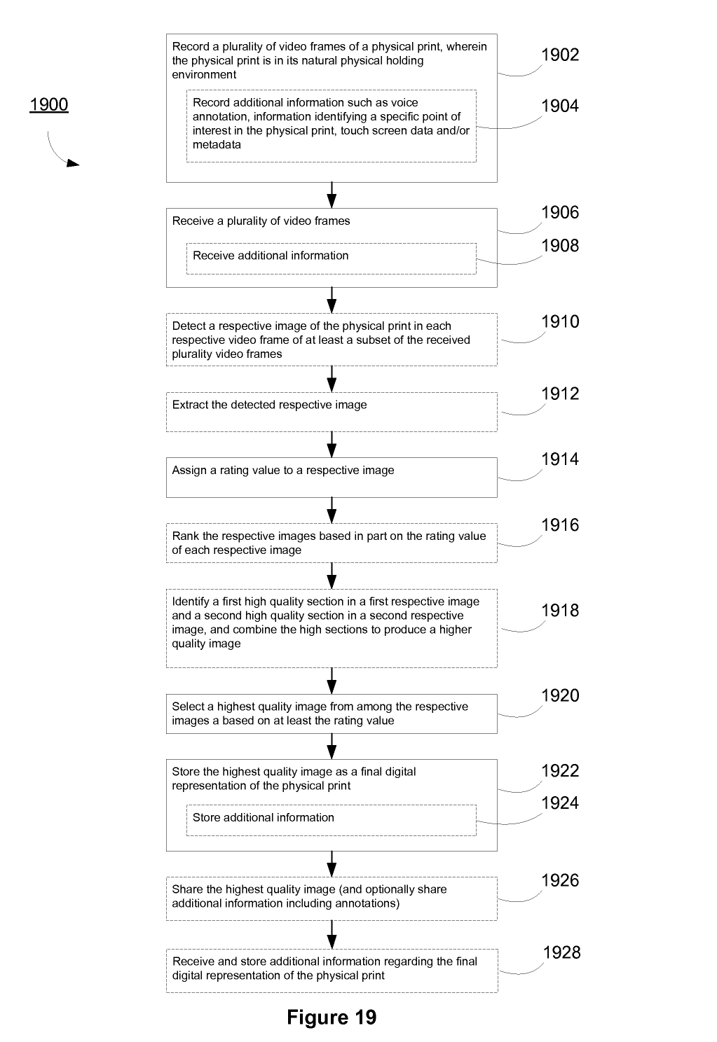

FIG. 19 is a flowchart representing a method 1900 for producing a final digital representation of a physical print according to certain embodiments. The method 1900 is typically governed by instructions that are stored in a computer readable storage medium and that are executed by one or more processors of one or more computer systems. In some embodiments the method is performed on a client system 1800. In other embodiments, the method (or portions thereof) is performed on a server system 1700. In still other embodiments, some portions of the method are performed on the client system 1800 while other portions are performed on the server system 1700. Each of the operations shown in FIG. 19 typically corresponds to instructions stored in a computer memory or non-transitory computer readable storage medium. The computer readable storage medium typically includes a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

It should be noted that FIG. 19 is provided merely to give a general overview or context to the claimed processes. More detail regarding this method is found in the remaining figures of this application.

In some embodiments, a computer-implemented method 1900 shown in FIG. 19 is performed on a computer system having one or more processors and memory storing one or more programs for execution by the one or more processors.

The client system (1800, FIG. 18), such as a hand held video recorder or video recorder portion of a phone or similar device, records a plurality of video frames of a physical print 1902. The physical print comprises any physical substantially flat media item. Some examples of physical prints include: a printed photograph, a picture, a painting, a ticket stub, a poster, a drawing, a collage, a document, a postcard, and any other similar physical substantially flat media item. In some embodiments, the user controls the client system to record the video frames. In some embodiments, the user also provides additional selection information regarding the physical print. For example, in some embodiments, the user identifies a portion of the screen or media item of interest. For example, the user may select only a picture portion from a newspaper. In other embodiments, the physical print is recognized automatically from the system (either in real time or in post recording processing depending on the embodiment.)

In some embodiments, the physical print is in its natural physical holding environment. Some examples of natural holding environment include a photo album, a picture frame, a scrapbook, a display casing, a plastic sleeve, and any other physical holding environment. In some embodiments, the recording of the plurality of video frames does not include removing the physical print from its natural holding environment. In other embodiments the user may record a plurality of physical prints from a pile of photographs. For example, the user can record a video of a plurality of physical prints during one video recording session when each of the photographic print is in a pile of photographic prints by (e.g., flipping through a pile of prints while video recording each print before flipping it and then moving to the next print while continuously video recording.) In some embodiments a plurality of physical prints are recorded by moving the camera along the pictures while they are in their natural holding environment (e.g., running the camera over each picture in a scrapbook or on a wall or an a table.)

In some embodiments, in addition to recording a plurality of video frames, additional information associated with the physical print is also recorded 1904. In some embodiments, a voice annotation is recorded by the client device. It is noted that some or all of the additional information is subsequently stored in association with the final digital representation of the physical print as described in more detail with respect to 1924. For example, if a voice annotation is recorded by the client, the client or server (or both depending on the implementation) stores the voice annotation in association with the final digital representation of the physical print. The voice annotation process can also be described as labeling, describing, or audio tagging information associated with the physical print, a portion thereof or a specific point of interest in the photograph. For example, in some embodiments, information identifying a specific point of interest in the physical print is provided. In some embodiments, the additional information is touch screen data (e.g. tapping on the portion of interest). In other embodiments, the additional information that can be captured and stored in association with the final digital representation of the physical print includes calculated or received metadata, e.g., data that describes or gives information about the video frame(s). In some embodiments, metadata includes motion data, statistical data, noise data, etc.

When the additional information includes a voice annotation, voice annotation can include voice annotations from multiple people. The voice annotations from multiple people recorded at 1904 are received while the video frames are recorded. It is noted that in some embodiments, additional information is received and stored subsequent to storing the final digital representation to the physical print at 1928. For example, a user's original voice annotation might be corrected or commented on by the user or another user. For example, the first annotation might say, “this was Aunt Jane in second grade,” and the additional annotation might say, “No, actual this was Aunt Jane in first grade, I can tell because she's standing outside of the apartment we moved from in 1955.” It is noted, the annotations might be in text rather than (or in addition to) voice annotations. In some embodiments, the original and subsequent additional information is stored at the server and accessible to everyone.

The server system (or client system depending on the embodiment) then receives a plurality of the recorded video frames 1906. It is noted that for the purposes of the remaining discussion the plurality of video frames each include a respective image of at least one physical print. As stated above, in some embodiments, a plurality of physical prints is recorded in a plurality of uninterrupted video frames, i.e., the user does not turn the video camera off. However, for the discussion below, only the video frames associated with a particular physical print are used for selecting the highest quality image of the physical print. In some embodiments, some or all of the additional information is also received 1908. It is also noted that the additional information may be associated with frames other than those with an image of the physical print (i.e., those described above with respect to 1906). For example it may be desirable to have frames which include relevant audio annotations or frames associated with camera motion whether or not they contain an image of the physical print.

In some embodiments, a respective image of the physical print is detected in at least some of the video frames 1910. In other words, each respective video frame of at least a subset of the plurality of video frames includes a detected image of the physical print. It is not essential that the video frames in which the image of the physical print is detected be uninterrupted. In other words, the subset may include disparate video frames from the originally received plurality of video frames.

Furthermore, in some embodiments, a respective image of the physical print is extracted from at least some of the video frames 1912. In some embodiments, the image is extracted from all of the subset of the plurality of video frames in which the image was detected. In other embodiments the image is extracted from only a subset of the frames in which it was detected. In some embodiments, the image is extracted from frames meeting one or more high quality image characteristics such as those meeting a stability threshold, or a clarity threshold or a glare threshold.

Then, for at least a subset of the plurality of video frames, or at least the frames in which the image was extracted, a rating value is assigned to each respective image of the physical print 1914. In some embodiments, the rating value is assigned in accordance with a rating criterion (or a plurality of rating criteria). In some embodiments, the rating criteria includes any or all of: a geometric distortion factor, a resolution factor, a color factor, a brightness factor, a contrast factor, a levelness factor, a squareness factor, another rating criteria, and any combination thereof. It is noted that the rating may be done in multiple passes based on various additional information received at 1908. For example any factor describe above may be rated in one pass and then the final rating value is produced by combining the factor's rating from each pass.

Then, in some embodiments, the respective images of the physical print are ranked based at least in part on the rating value of each respective image 1916.

In some embodiments, a first high quality section of a first respective image of the physical print is identified in a first video frame, a second high quality section of a second respective image of the physical print is identified in a second video, and then the first high quality section is combined with the second high quality section to produce a higher quality image 1918. As such the final highest quality image is essentially a stitched together image from at least two frames each including a high quality portion of the physical print. In this way glare, reflections, camera lens dirt, and other inadequacies can be removed from the final highest quality image (even if they existed in some portion of every video frame.)

A highest quality image of the physical print is selected from among the respective images 1920. In some embodiments, this includes selecting the combined higher quality image produced at 1918. The selection based on at least the rating value of the selected image.

Then, the highest quality image is stored as a final digital representation of the physical print 1922. In some embodiments, some or all of the additional information received at 1908 is also stored. For example, if metadata associated with the image of the physical print was received, in some embodiments some of the metadata is stored in association with the final digital representation of the physical print. In some embodiments, information identifying a specific point of interest in the physical print is received, and the information identifying a specific point of interest is stored in association with the final digital representation of the physical print at 1922. In some embodiments, the information identifying a specific point of interest in the physical print is touch screen data associated with the image of the physical print. For example, the touch screen data associated with the image of the physical print may be received at 1908 and then the touch screen data is stored in association with the final digital representation of the physical print.

In some embodiments, the highest quality image is then available for sharing 1920. For example, a user may select the image and post it to a social networking sight. It may also be available on a photo hosting site. In some embodiments, the user can choose whether or not to share additional information such as written or spoken annotations.

After a user may also provide, or allow others to provide additional information such as augmented annotations about the final digital representation of the physical print 1928. For example, in some embodiments, either as a part of the information received at 1908 or 1928, information identifying a specific point of interest in the physical print is received, and the information identifying a specific point of interest is stored at 1924 or 1928 in association with the final digital representation of the physical print.

With respect to 1918, it is specifically noted that in some embodiments a method performed as follows. A plurality of video frames are received 1906. Each frame includes an image of a physical print. A first high quality section of the physical print is identified in a first video frame of the plurality of video frames, a second high quality section of the physical print is identified in a second video frame of the plurality of video frames, and the first high quality section with the second high quality section to produce a higher quality image 1918. Then the higher quality image is stored as a final high quality digital representation of the physical print 1922.

It is noted that in embodiments in which the processing steps 1902-1920 take place on a client device, such as a personal computer, smart phone, or tablet computer, the processing is done in real time. As such only the best frames and additional information of interested need be selected and stored.

It is also noted that in some embodiments, the plurality of video frames includes a second image of a second physical print as well. In these embodiments steps 1908-1928 are performed for the second image of the second print as well. In some embodiments, the processing of the first image is done first and then the second image is processed. In other embodiments the first and second images are processed simultaneously. It is also noted that one video “take” may contain numerous physical prints each processed according to the steps described above. In some embodiments, it is then possible using the annotation information provided, image recognition data, or other means to group the final digital representations of the physical prints into categories. For example, by person (these are all pictures of Sister Susan or these are all pictures from 1958.)

In some embodiments, a computer system, comprising one or more processors; and memory storing one or more programs to be executed by the at least one processor is provided. In some embodiments, the computer system is a client system such as a hand held mobile device. In other embodiments it is a server system. The system performs any or all of the method steps described above. Specifically, the system includes instructions for receiving a plurality of video frames each including a respective image of a physical print. It includes instructions for at least a subset of the plurality of video frames, rating each respective image of the physical print in accordance with rating criteria to produce a rating value. The instructions also include selecting a highest quality image of the physical print based on at least the respective image's rating value. And finally include instructions for storing the highest quality image as a final digital representation of the physical print. In some embodiments, the instructions also include instructions to perform one or more of the additional steps described in FIG. 19.

In some embodiments, a non-transitory computer readable storage medium storing one or more programs configured for execution by a computer is provided. The storage medium includes instructions for receiving a plurality of video frames each including a respective image of a physical print. It includes instructions for at least a subset of the plurality of video frames, rating each respective image of the physical print in accordance with rating criteria to produce a rating value. The instructions also include selecting a highest quality image of the physical print based on at least the respective image's rating value. And finally include instructions for storing the highest quality image as a final digital representation of the physical print. In some embodiments, the instructions also include instructions to perform one or more of the additional steps described in FIG. 19.

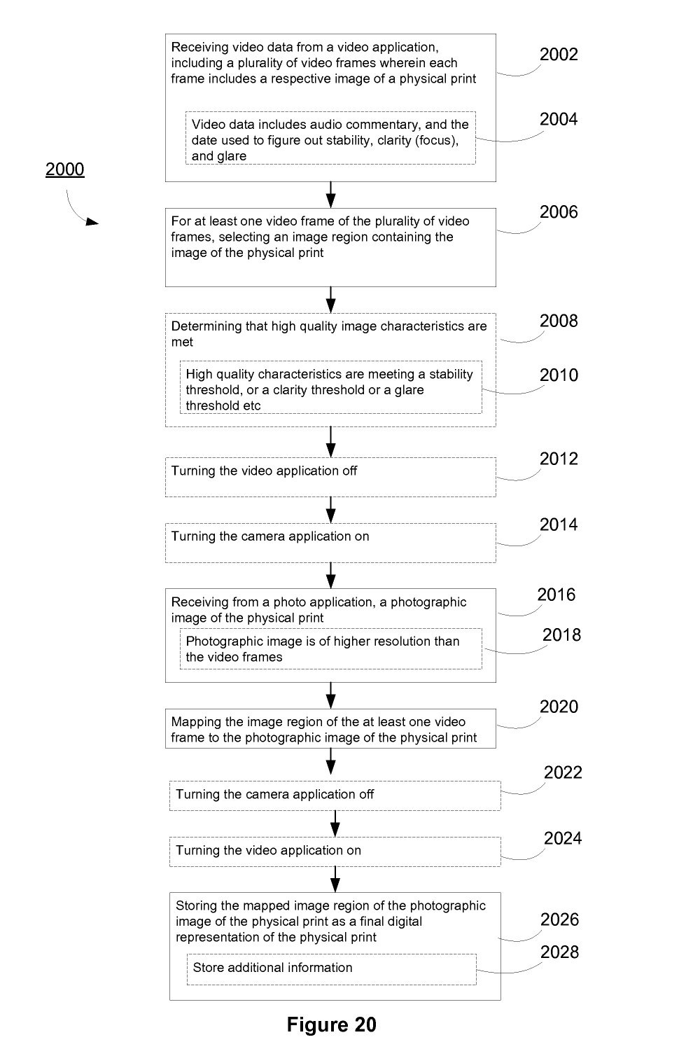

FIG. 20 is a flowchart representing a method 2000 for producing a final digital representation of a physical print according to certain embodiments. The method 2000 is typically governed by instructions that are stored in a computer readable storage medium and that are executed by one or more processors of one or more computer systems. In some embodiments the method is performed on a client system 1800. In other embodiments, the method (or portions thereof) is performed on a server system 1700. In still other embodiments, some portions of the method are performed on the client system 1800 while other portions are performed on the server system 1700. Each of the operations shown in FIG. 20 typically corresponds to instructions stored in a computer memory or non-transitory computer readable storage medium. The computer readable storage medium typically includes a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

It should be noted that FIG. 20 is provided merely to give a general overview or context to the claimed processes. More detail regarding this method is found in the remaining figures of this application.

In some embodiments, a computer-implemented method 2000 shown in FIG. 20 is performed on a computer system having one or more processors and memory storing one or more programs for execution by the one or more processors.

The client system (1800, FIG. 18), such as a hand held video recorder or video recorder portion of a phone or similar device, records video data 2002. The video data also includes a plurality of video frames of a physical print. In some embodiments, the video data includes audio commentary, and data regarding stability, clarity (focus), glare, and other metadata 2004.

For at least one video frame of the plurality of video frames, an image region containing the image of the physical print is selected 2006. It is noted that various image regions might be selected in various video frames. For example if the physical print were a Polaroid photograph, one image region might include the whole Polaroid, while another just includes the picture itself.

Optionally, in some embodiments, it is determined that one or more high quality image characteristics are met 2008. In some embodiments this includes meeting a stability threshold 2010. In other embodiments, this includes meeting a clarity threshold 2010. In still other embodiments, this includes meeting a glare threshold 2010. However, meeting any of these thresholds is not necessary in all embodiments to determine that high quality image characteristics are met.

Optionally, depending on the functionality of the device, the video application is briefly turned off 2012. Then optionally, depending on the functionality of the device, a camera application is turned on 2014. It is noted some devices to not require turning off a video application in order to use a camera application. It is also noted that the same processes are applied in embodiment in which two different resolution devices are utilized. As such camera application is defined as a higher resolution application than the video application (although it need not be a traditional camera application.)

The a photographic image of the physical print is received from the photo application 2016. The a photographic image of the physical print is of higher resolution that the video frames 2018. In some embodiments, the photographic image meets the high quality image characteristics. For example the system monitors the video stream real time and snaps a picture using the photo application when the conditions are optimal (e.g., there is no glare, the picture is in focus, the camera is not shaking etc.) In some embodiments, more than one photograph is taken during this process, in other words steps 2008-2018 are performed more than once.

Then the image region of at least one video frame is mapped to at least one photographic image of the physical print 2020.

Optionally, depending on the functionality of the device, the camera application is turned off 2022. Then optionally, depending on the functionality of the device, the video application is turned on 2024. It is noted that in some embodiments, the process of taking the picture and turning off and on the video application is so seamless that the experience to the user is of an uninterrupted video graphic experience. In some embodiments, when the picture is taken an indication of picture taking is performed, for example, an illustration of a camera shutter opening an closing is played. This indicates to the user that a high quality picture has been obtained. The receiving of video data is continued. This video data may include for example, audio commentary by the user regarding the physical print.

Finally, the mapped image region of the photographic image of the physical print is stored as a final digital representation of the physical print 2026. Optionally, in some embodiments, any or all additional information received as part of the video data is also stored (including for example audio commentary by the user) 2028.

Each of the methods described herein is typically governed by instructions that are stored in a computer readable storage medium and that are executed by one or more processors of one or more servers or clients. The above identified modules or programs (i.e., sets of instructions) need not be implemented as separate software programs, procedures or modules, and thus various subsets of these modules will be combined or otherwise re-arranged in various embodiments.

What is claimed is:

1. A computer-implemented method performed on a computer system having one or more processors and memory storing one or more programs for execution by the one or more processors, the method comprising:
receiving a plurality of video frames each including a respective image of a physical print;
for at least a subset of the plurality of video frames, assigning a rating value to each respective image of the physical print in accordance with a rating criteria;
selecting a highest quality image of the physical print from among the respective images, the selection based on at least the rating value of the selected image; and
storing the highest quality image as a final digital representation of the physical print.

2. The computer-implemented method of claim 1, wherein the method includes, prior to the receiving:
recording the plurality of video frames each including a respective image of the physical print, wherein the physical print is in its natural physical holding environment.

3. The computer-implemented method of claim 2, wherein the natural physical holding environment is selected from the group consisting of: a photo album, a picture frame, a scrapbook, a display casing, a plastic sleeve, and any other physical holding environment.

4. The computer-implemented method of claim 2, wherein recording the plurality of video frames does not include removing the physical print from its natural holding environment.

5. The computer-implemented method of any of claims 1-4, wherein the method includes, prior to the selecting:
identifying a first high quality section of a first respective image of the physical print in a first video frame of the plurality of video frames;
identifying a second high quality section of a second respective image of the physical print in a second video frame of the plurality of video frames; and
combining the first high quality section with the second high quality section to produce a higher quality image.

6. The computer-implemented method of any of claims 1-5, wherein the method includes, prior to the selecting:
ranking the respective images of the physical print based at least in part on the rating value of each respective image.

7. The computer-implemented method of any of claims 1-6, wherein the method includes, prior to the selecting:
extracting a respective image of the physical print from at least a subset of the plurality of video frames.

8. The computer-implemented method of claim 7, wherein the method includes, prior to the extracting:
detecting a respective image of the physical print in each respective video frame of at least a subset of the plurality of video frames.

9. The computer-implemented method of any of claims 1-8, wherein the computer system is a server system.

10. The computer-implemented method of any of claims 1-8, wherein the computer system is a client system comprising any of a personal computer, a smart phone, and a tablet computer.

11. The computer-implemented method of any of claims 1-10, wherein the physical print comprises any physical substantially flat media item selected from the group consisting of: a picture, a photograph, a painting, a ticket stub, a poster, a drawing, a collage, a document, a postcard, and any other similar physical substantially flat media item.

12. The computer-implemented method of any of claims 1-11, wherein a rating criteria is selected from the group consisting of: a geometric distortion factor, a resolution factor, a color factor, a brightness factor, a contrast factor, a levelness factor, a squareness factor, another rating criteria, and any combination thereof.

13. The computer-implemented method of any of claims 1-12, wherein the method includes, prior to the receiving:
recording a voice annotation associated with the physical print; and
wherein the storing further comprises storing the voice annotation in association with the final digital representation of the physical print.

14. The computer-implement method of claim 13, wherein the voice annotation includes an audio marker.

15. The computer-implement method of claim 13, wherein the voice annotation includes voice annotations from multiple people.

16. The computer-implemented method of any of claims 1-15, wherein the method includes, prior to the receiving:
receiving information identifying a specific point of interest in the physical print; and
wherein the storing further comprises storing the information identifying a specific point of interest in association with the final digital representation of the physical print.

17. The computer-implemented method of any of claim 16, wherein the information identifying a specific point of interest in the physical print is touch screen data associated with the image of the physical print.

18. The computer-implemented method of any of claims 1-15, wherein the method includes, prior to the receiving:
receiving touch screen data associated with the image of the physical print; and
wherein the storing further comprises storing the touch screen data in association with the final digital representation of the physical print.

19. The computer-implemented method of any of claims 1-18, wherein the method includes, prior to the receiving:
receiving metadata associated with the image of the physical print; and
wherein the storing further comprises storing the metadata in association with the final digital representation of the physical print.

20. The computer-implemented method of any of claims 1-19, wherein each of at least a subset of the plurality of video frames includes a second respective image of a second physical print.

21. A computer system, comprising:
one or more processors; and
memory storing one or more programs to be executed by the at least one processor;
the one or more programs comprising instructions for:
receiving a plurality of video frames each including a respective image of a physical print;
for at least a subset of the plurality of video frames, rating each respective image of the physical print in accordance with rating criteria to produce a rating value;
selecting a highest quality image of the physical print based on at least the respective image's rating value; and
storing the highest quality image as a final digital representation of the physical print.

22. A computer system, comprising:
one or more processors; and
memory storing one or more programs for execution by the one or more processors;
the one or more programs comprising instructions to be executed by the one or more processors so as to perform the method of any of claims 1-20.

23. A non-transitory computer readable storage medium storing one or more programs configured for execution by a computer, the one or more programs comprising instructions for:
receiving a plurality of video frames each including a respective image of a physical print;
for at least a subset of the plurality of video frames, rating each respective image of the physical print in accordance with rating criteria to produce a rating value;
selecting a highest quality image of the physical print based on at least the respective image's rating value; and
storing the highest quality image as a final digital representation of the physical print.

24. A non-transitory computer readable storage medium storing one or more programs configured for execution by one or more processors of a computer system, the one or more programs comprising instructions to be executed by the one or more processors so as to perform the method of any of claims 1-20.

25. A method performed on a computer system having one or more processors and memory storing one or more programs for execution by the one or more processors, the method comprising:
receiving a plurality of video frames each including an image of a physical print;
identifying a first high quality section of the physical print in a first video frame of the plurality of video frames;
identifying a second high quality section of the physical print in a second video frame of the plurality of video frames;
combining the first high quality section with the second high quality section to produce a higher quality image; and
storing the higher quality image as a final high quality digital representation of the physical print.

26. A computer-implemented method performed on a computer system having one or more processors and memory storing one or more programs for execution by the one or more processors, the method comprising:
receiving video data from a video application, including a plurality of video frames wherein at least some frame includes a respective image of a physical print;
for at least one video frame of the plurality of video frames, selecting an image region containing the image of the physical print;
determining that high quality image characteristics are met;
turning the video application off;
turning a camera application on;
receiving from a photo application, a photographic image of the physical print meeting the high quality image characteristics;
mapping the image region of the at least one video frame to the photographic image of the physical print;
turning the camera off;
turning the video capture on; and
storing the mapped image region of the photographic image of the physical print as a final digital representation of the physical print.

27. A computer-implemented method performed on a computer system having one or more processors and memory storing one or more programs for execution by the one or more processors, the method comprising:
receiving video data from a video application, including a plurality of video frames wherein each frame includes a respective image of a physical print;
for at least one video frame of the plurality of video frames, selecting an image region containing an image of the physical print;
receiving from a photo application, a photographic image of the physical print;
mapping the image region of the at least one video frame to the photographic image of the physical print; and
storing the mapped image region of the photographic image of the physical print as a final digital representation of the physical print.

28. A computer system, comprising:
one or more processors; and
memory storing one or more programs for execution by the one or more processors;
the one or more programs comprising instructions to be executed by the one or more processors so as to perform the method of any of claims 25-27.

29. A non-transitory computer readable storage medium storing one or more programs configured for execution by one or more processors of a computer system, the one or more programs comprising instructions to be executed by the one or more processors so as to perform the method of any of claims 25-27.
